(19) United States
(12) Patent Application Publication
(10) Pub. No.: US 2026/0009096 A1
(43) Pub. Date: Jan. 8, 2026

(54) ELECTRIC FURNACE EQUIPMENT AND METHOD FOR MANUFACTURING MOLTEN METAL

(71) Applicant: POSCO CO., LTD, Pohang-si, Gyeongsangbuk-do (KR)

(72) Inventors: Chan Joon PAEK, Seongnam-si (KR); Ho Hyun JEOUNG, Pohang-si (KR); Baek LEE, Seoul (KR); Jong Hun SHIN, Gwangju (KR); Myoung Kuk KO, Suncheon-si (KR); Do Eung KIM, Pohang-si (KR); Chung Jin SONG, Pohang-si (KR); Jin Young KIM, Pohang-si (KR); Seong Hun HONG, Incheon (KR)

(73) Assignee: POSCO CO., LTD, Pohang-si, Gyeongsangbuk-do (KR)

(21) Appl. No.: 18/868,574

(22) PCT Filed: Dec. 7, 2023
(86) PCT No.: PCT/KR2023/020099

§ 371 Date: Sep. 25, 2025

(30) Foreign Application Priority Data
Dec. 9, 2022 (KR) 10-2022-0171769

(51) Int. Cl. C21B 13/12; F27B 3/08; F27D 19/00; F27D 21/02; H05B 7/148; H05B 7/20

(52) U.S. Cl. CPC C21B 13/12; F27B 3/085; F27D 19/00; F27D 21/02; H05B 7/148; H05B 7/20; F27D 2019/0071; F27D 2019/0075; F27D 2021/026

(57) ABSTRACT

An electric furnace equipment including: a body part having an inner space capable of processing a raw material; an electrode part installed to be inserted into the inner space of the body part; an input part installed in the body part to be capable of inputting the raw material to the inner space of the body part; and a photographing part installed in the body part to be capable of photographing the area around the electrode part in the inner space of the body part; and an input control part which detects a spacing distance (Dₘ) between the electrode part and a raw material stack formed by the raw material stacked around the electrode part by using a photograph image acquired by the photographing part and controls an input of the raw material input to the body part from the input part according to the detected spacing distance (Dₘ).

### TECHNICAL FIELD

The present invention relates to electric furnace equipment and a method for manufacturing molten metal, and more specifically, to electric furnace equipment capable of performing uniform operation and a method for manufacturing molten metal.

### BACKGROUND ART

Recently, carbon-neutral technologies that minimize carbon dioxide emissions are being actively developed in response to the climate change crisis. Accordingly, the steel industry is researching and developing hydrogen reduction steelmaking process technology that produces direct reduced iron using hydrogen instead of fossil fuels, which emit carbon dioxide, and utilizes the direct reduced iron to produce steel. When hydrogen reduction steelmaking process technology is commercialized, it can replace not only the blast furnace operation, which generates a large amount of carbon dioxide, but also the converter operation by utilizing electric furnace operations.

The direct reduced iron is melted by the heat generated at an electrode part of the electric furnace equipment. However, the direct reduced iron has a high content of metallic iron. Therefore, if the direct reduced iron comes into contact with the electrode part of the electric furnace equipment, stable operation becomes impossible due to oversupply of current or changes in the current path caused by variations in resistance. Additionally, if the spacing distance between the electrode part and the raw material pile is excessively large, there is an issue of decreased operating rate in the electric furnace equipment.

(Prior Art Document) (Patent Document 1) Korean Registration No. 10-1406503

### DISCLOSURE OF THE INVENTION

### Technical Problem

The present invention provides electric furnace equipment capable of performing uniform operation and a method for manufacturing molten metal.

The present invention provides electric furnace equipment capable of uniformly heating a raw material and a method for manufacturing molten metal.

The present invention provides electric furnace facility capable of allowing a uniform current to flow through an electrode part and a method for manufacturing molten metal.

### Technical Solution

Electric furnace equipment according to the embodiments of the present invention includes a body part having an inner space capable of processing a raw material; an electrode part installed to be inserted into the inner space of the body part; an input part installed in the body part to be capable of inputting the raw material to the inner space of the body part; a photographing part installed in the body part to be capable of photographing an area around the electrode part in the inner space of the body part; and an input control part which detects a spacing distance Dₘ between the electrode part and a raw material pile generated by the raw material piled around the electrode part by using a photograph image acquired by the photographing part and controls an input of the raw material input to the body part from the input part according to the detected spacing distance Dₘ.

The electric furnace equipment may further include a supply part configured to supply the raw material to the input part and connected to the input part to, adjust an amount of raw material supplied to the input part, wherein the input control part is configured to control an operation of the supply part according to the detected spacing distance Dₘ.

The input control part may be configured to control the input of the raw material input to the body part according to the spacing distance Dₘ between the pile of the raw material piled around the electrode part and the electrode part and controls the input of the raw material input closer to an inner wall of the body part than the electrode part using data different from the spacing distance Dₘ.

The body part may include: a furnace body having the inner space; and a cover configured to cover an upper portion of the furnace body, wherein the electrode part and the input part are installed to pass through the cover in a vertical direction, and the photographing part is installed to a sidewall of the furnace body, to photograph the inner space of the body part.

A hole, which passes through the sidewall of the furnace in a thickness direction, may be defined, the photographing part is installed to be inserted to the hole, a transmissive window is installed to one end of the hole facing the inner surface of the furnace body, and the photographing part is installed to face the window.

The photographing part may be installed to be inclined so that a height thereof decreases toward one end facing the inner space.

The input part may include: a first input part installed to be disposed around the electrode part; and a second input part installed outside the first input part to be farther from the electrode part than the first input part, wherein the photographing part is installed to acquire the photograph image including a first raw material pile, which is generated by inputting the raw material input from the first input part inside the body part, and the electrode part.

The supply part may include: a first supply part configured to supply the raw material to the first input part; and a second supply part configured to supply the raw material to the second input part, wherein the input control part may include: a first input control part configured to detect the spacing distance Dₘ between the electrode and the first raw material pile by using the photograph image, thereby controlling an operation of the first supply part by using the detected spacing distance Dₘ; and a second input control part configured to control an operation of the second supply part.

The first input control part may include: an identification image generator configured to identify the electrode part and the first raw material pile in the photograph image to generate an identification image in which the electrode part and the first raw material pile, which are identified, are distinguished from each other; a distance detector configured to detect the spacing distance Dₘ between the electrode part and the first raw material pile by using the identification image; and a first input controller configured to control the operation of the first supply part based on the spacing distance Dₘ detected by the distance detector, wherein the first input controller may be determined to determine a method of inputting the raw material from the first input part as one of maintenance, increase and decrease of the input amount, or stopping of the input, by using the detected spacing distance Dₘ and a preset reference spacing distance.

The electric furnace equipment may further include a first sensor unit disposed at one side of the first input part to detect the spacing distance between the first raw material pile and the cover, wherein the first input control part may include a first height detector configured to detect a height H_{cm} of the first raw material pile by using the spacing distance between the first raw material pile and the cover, which is detected by the first sensor unit, and the first input controller is configured to determine the input amount of raw material to be input through the first input part by using the height H_{cm} of the first raw material pile, when the input method from the first input part is determined as one of the increase and decrease of the input amount.

The first input control part may include a second height detector configured to detect a height H_{cm} of the first raw material by using the identification image, and the first input controller may be configured to determine the input amount of raw material to be input through the first input part by using the height H_{cm} of the first raw material pile, when the input method from the first input part is determined as one of the increase and decrease of the input amount.

The first input controller may be configured to determine the input amount of raw material to be input through the first input part by using a difference between the detected spacing distance Dₘ and the reference spacing distance, when the input method from the first input part is determined as one of the increase and decrease of the input amount.

The electric furnace equipment may further include a second sensor unit disposed at one side of the second input part to detect a spacing distance between a second raw material pile, which is generated by the raw material input from the second input part inside the body part, and the cover, wherein the second input control part may include: a third height detector configured to detect a height Hₛₘ of the second raw material pile by using the spacing distance between the second raw material pile and the cover, which is detected by the second sensor unit; and a second input controller configured to control an operation of the second supply part, thereby controlling at least one of whether to input the raw material from the second input part or the input amount of raw material, based on the detected height Hₛₘ Of the second raw material pile.

A method of manufacturing molten metal includes:

inputting a raw material to an electric furnace; supplying power to an electrode part disposed in the electric furnace to melt the raw material; photographing the inside of the electric furnace to acquire a photograph image including the electrode part and a raw material pile piled around the electrode part; detecting a spacing distance Dₘ between the electrode part and the raw material pile by using the photograph image; and controlling an input of the raw material input around the electrode part by using the detected spacing distance Dₘ between the electrode part and the raw material pile.

The detecting of the spacing distance Dₘ between the electrode part and the raw material r pile may include: identifying the electric part and the raw material pile in the photograph image to generate an identification image through which the electrode part and the raw material pile, which are identified, are distinguished from each other; and detecting a spacing distance Dₘ between the electrode part and the raw material pile identified through the identification image.

The controlling of the input of the raw material input around the electrode part may include: determining an input method as one of maintenance, increase, and decrease of the input amount, and stopping of the input based on the detected spacing distance between the electrode part and the raw material pile; and inputting the raw material around the electrode part according to the determined input method.

The method may further include a detecting a height of the raw material, wherein when the input method is determined as one of the increase and decrease of the input amount in the determining of the input method, the controlling of the input of the raw material input around the electrode part may include determining the input amount of raw material by using the detected height of the raw material pile, and in the inputting of the raw material based on the determined input method, the determined input amount of raw material is input.

The detecting of the height of the raw material pile may include: emitting electromagnetic waves or light to the raw material pile by using a sensor unit disposed above the raw material pile to detect a spacing distance between the sensor unit and the raw material pile; and detecting a height H_{cm} of the raw material pile by using the detected spacing distance between the sensor unit and the raw material pile.

The method may further include judging malfunction of the sensor unit, wherein the judging of the malfunction of the sensor unit may include comparing the detected spacing distance between the sensor unit and the raw material pile and a predetermined malfunction judgement distance to judge the malfunction of the sensor unit, when it is judged that the malfunction of the sensor unit occurs, the detecting of the height H_{cm} of the raw material pile may include detecting a height H_{cm} of the raw material pile, which is identified on the identification image.

When the input method is determined as one of the increase and decrease of the input amount in the determining of the input method, the controlling of the input of the raw material input around the electrode part may include determining an input amount of raw material by using a difference between the detected spacing distance Dₘ between the electrode part and the raw material pile and a preset reference spacing distance, wherein in the inputting of the raw material based on the determined input method, the determined amount of raw material may be input.

The method may further include inputting the raw material into a portion closer to an inner wall of the electric furnace than the electrode part, by using data different from the detected spacing distance Dₘ between the electrode part and the raw material pile.

The method may further include: detecting a height Hₛₘ of a second raw material pile formed in the electric furnace, which is farther from the electrode part, compared to a first raw material pile, which is the raw material pile piled around the electrode part; detecting a height Hₛₘ of the second raw material pile provided in the electric furnace, which is farther from the electrode part than, the first raw material pile; determining an input method as one of maintenance, increase, and decrease of the input amount, and stopping of the input, by using a size relationship between the detected height Hₛₘ of the second raw material pile and a preset reference height; and determining an input amount of raw material, by using a difference between the detected height Hₛₘ of the second raw material pile and the reference height, wherein the inputting of the raw material to a position farther from the electrode part than, the first raw material pile may include inputting the raw material based on the input method and input amount determined by the height Hₛₘ of the second raw material pile.

The raw material may include hydrogen directly reduced iron, which is reduced by the hydrogen.

### Advantageous Effects

Therefore, according to the exemplary embodiments, the spacing distance between the electrode part and the raw material pile may be detected. In addition, the input of the raw material may be controlled according to the detected spacing distance between the electrode part and the raw material pile. This may prevent the electrode part from coming into contact with the raw material pile. Therefore, when power is applied to the electrode part, it is possible to prevent the hunting of current from occurring at the electrode part. As a result, a uniform current may flow through the electrode part. Therefore, it is possible to heat the raw materials uniformly, which allows for uniform operations. Additionally, it may prevent issues such as the decrease in operating rate of electric furnace equipment and the production rate of molten metal due to hunting. Thus, the operating rate of the electric furnace equipment and the production rate of the molten metal may be improved.

In addition, the electrode unit and the raw material pile may be adjusted to be spaced at a predetermined distance apart from each other, allowing the slag to be exposed to an appropriate area. Therefore, the loss of heat and erosion of refractories caused by the exposed slag may be suppressed or prevented.

### BRIEF DESCRIPTION OF THE DRAWINGS

FIG. 1 is a plan view of an electric furnace equipment in accordance with an exemplary embodiment when viewed from above.

FIG. 2 is a cross-sectional view of the electric furnace equipment in accordance with an exemplary embodiment.

FIG. 3 is a plan view of a portion illustrated in FIG. 1.

FIG. 4 is a plan view of a body part of the electric furnace equipment in accordance with an exemplary embodiment when viewed from above, and a plan view illustrating a raw material pile, slag, and electrode inside the body part.

FIG. 5A is an example of a photograph image Is acquired from a photographing part in accordance with an exemplary embodiment, and FIG. 5B is an example of an identification image Id generated using the photograph image Iₛ.

FIG. 6A is a view illustrating a method of detecting a height of a first raw material pile using a first sensor unit and a first height detector in accordance with an exemplary embodiment.

FIG. 6B is a view illustrating a method of detecting a height of a second material pile using a second sensor unit and a third height detector in accordance with an exemplary embodiment.

FIG. 7 is a flowchart illustrating a method of inputting a raw material to the body part using a first input control part in accordance with an exemplary embodiment.

FIG. 8 is a flowchart illustrating a method of inputting a raw material to the body part using a second input control part in accordance with an exemplary embodiment.

### MODE FOR CARRYING OUT THE INVENTION

Hereinafter, embodiments of the present disclosure will be described in more detail with reference to the accompanying drawings. The present disclosure may, however, be embodied in different forms and should not be construed as limited to the exemplary embodiments set forth herein. Rather, these embodiments are provided so that this disclosure will be thorough and complete, and will fully convey the scope of the present disclosure to those skilled in the art. In the drawings, the dimensions are exaggerated for clarity of illustration, and like reference numerals refer to like elements throughout.

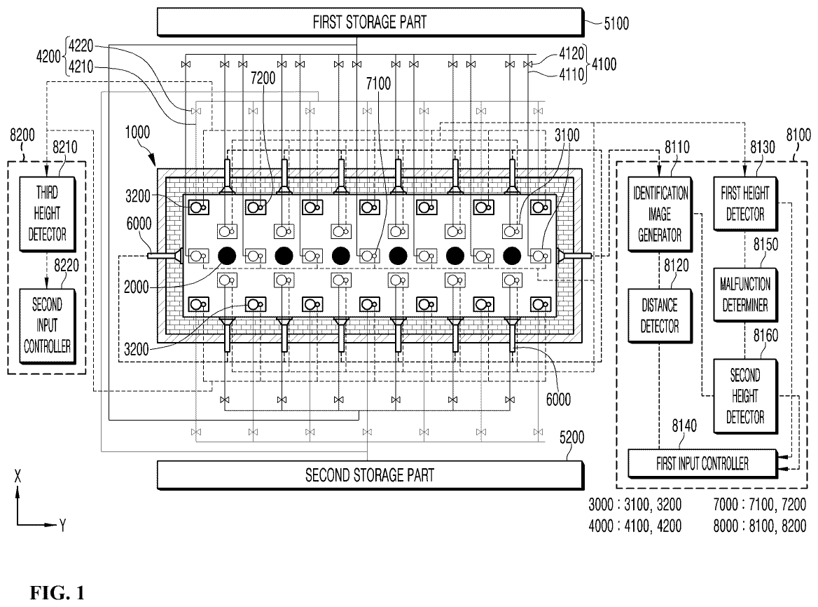

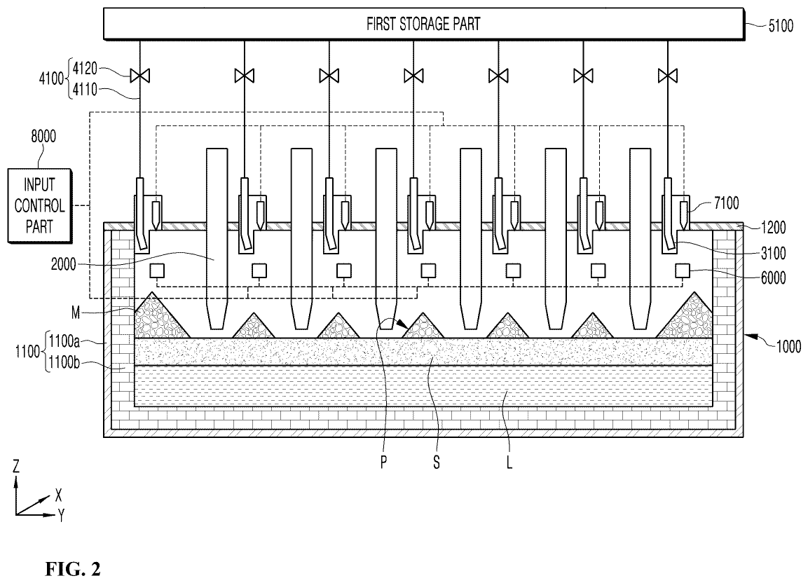

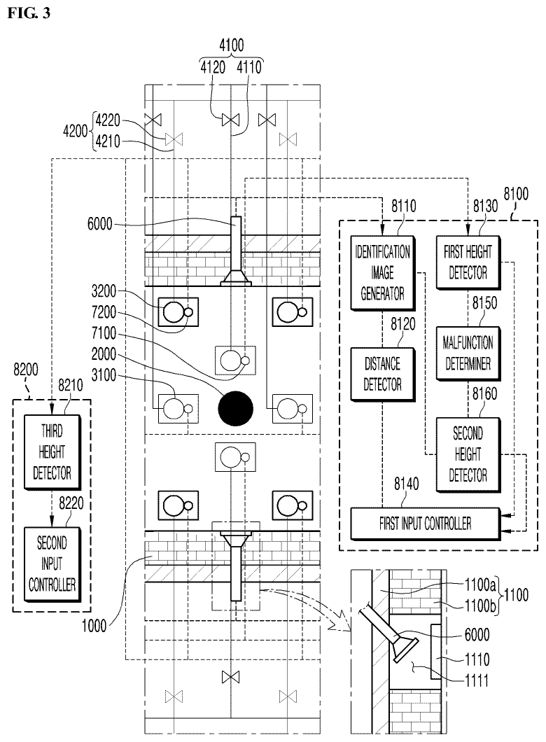

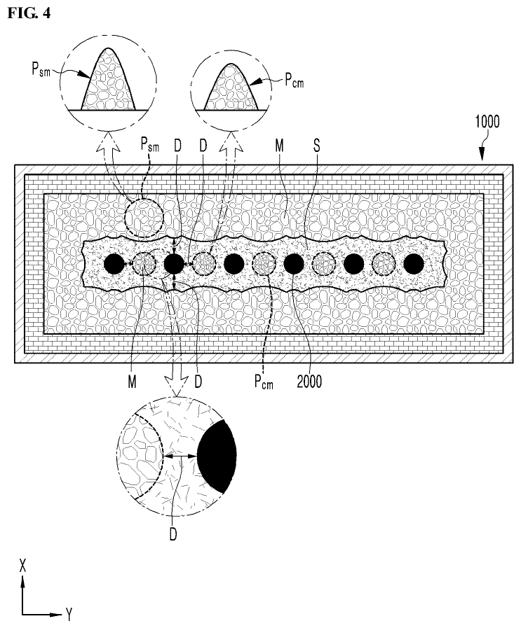

FIG. 1 is a plan view of an electric furnace equipment in accordance with an exemplary embodiment when viewed from above. FIG. 2 is a cross-sectional view of the electric furnace equipment in accordance with an exemplary embodiment. FIG. 3 is a plan view of a portion illustrated in FIG. 1. FIG. 4 is a plan view of a body part of the electric furnace equipment in accordance with an exemplary embodiment when viewed from above, and a plan view illustrating a raw material pile, slag, and electrode inside the body part.

Here, FIG. 2 is a cross-sectional view of an electrode part and a first input part in accordance with an exemplary embodiment.

The electric furnace equipment is a device that melts a raw material input thereto to manufacture molten material, i.e., molten metal. Referring to FIGS. 1 and 2, the electric furnace equipment includes a body part 1000 having an inner space capable of processing a raw material, an electrode part 2000 installed to body part to supply heat for melting the raw material M inside the body part 1000, an input part 3000 installed to the body part 1000 to input the raw material M to the body part 1000, a supply part 4000 that supplies the raw material M to the input part 3000, a photographing part 6000 installed to the body part 1000 to photograph inside the body part 1000, and an input control part 8000 that detects a spacing distance between a pile Pₘ generated by piled raw material and the electrode part 2000 using an image acquired from the photographing part 6000 and controls an operation of the supply part 4000 according to the detected spacing distance.

Additionally, the electric furnace equipment may include a storage part 5000 where the raw material M to be supplied to the supply part is stored, a sensor unit 7000 installed to the body part 1000 to measure a height of the raw material pile Pₘ piled inside the body part 1000, and a power supply part (not shown) connected to the electrode part 2000 to apply power.

The raw material M input to the inner space of the body part 1000 may include direct reduced iron DRI. In addition, a reducing agent is input into the body part 1000 to reduce the DRI, and the reducing agent may be a gas containing hydrogen. A more specific example is that the reducing agent may be a hydrogen gas. The reducing agent, which is a gas containing hydrogen, may be input into the body part through a reducing agent supply pipe installed separately from the input part 3000, for example, connected to the body part 1000.

When power is applied to the electrode part 2000 and heat is generated inside the body part 1000, the raw material M, i.e., the DRI, melts. Also, the raw material M is reduced by the reducing agent containing hydrogen, thereby manufacturing molten metal L.

The DRI may be at least one of low-grade direct reduced iron, which is manufactured using ore with an iron Fe content of less than 65 wt %, and high-grade direct reduced iron, which is manufactured using ore with an iron Fe content of 65 wt % or more.

Also, when using materials containing hydrogen as a reducing agent, the DRI reduced by hydrogen may be named ‘hydrogen direct reduced iron’. Therefore, the electric furnace equipment that melts and reduces the hydrogen direct reduced iron to manufacture molten metal L may be named An electric furnace equipment for melting hydrogen reduced direct reduced Iron′.

The above describes the use of a material containing hydrogen as a reducing agent. However, various materials, for example, cokes, may be used as the reducing agent to reduce direct reduced iron.

Additionally, the raw materials introduced into the body part 1000 are not limited to direct reduced iron, and may include scrap with a higher iron Fe content than the direct reduced iron. A scrap may be an iron scrap with an iron Fe content exceeding 70 wt %, more preferably iron scrap with an iron Fe content of 85 wt % to 99 wt %.

Referring to FIG. 2, the body part 1000 may include a furnace body 1100 having an inner space and a cover 1200 that covers an opening defined in an upper portion of the furnace body 1100.

The furnace body 1100 may have a cylinder shape with an inner space and an opened upper portion thereof. This furnace body 1100 may include an outer wall structure 1100a made of steel sheet or metal as shown in FIGS. 1 and 2, and an inner wall structure 1100b constructed of refractory material to surround an inner wall of the outer wall structure 1100a.

The furnace body 1100 may be provided with a first outlet (not shown) for discharging the molten metal L and a second outlet (not shown) for discharging a slag S floating on an upper portion of the molten metal L. Each of the first and second outlets may be provided on a sidewall of the furnace body 1100 or at a bottom of the furnace body 1100. For example, the first outlet may be provided on one sidewall of the furnace body 1100, and the second outlet may be provided on the other sidewall of the furnace body 1100. Here, the first and second outlets are not limited to the above-mentioned positions and may be provided a various positions capable of discharging the molten metal L and slag S to the outside.

A container capable of accommodating each of the molten metal L and the slag S is disposed outside of the furnace body 1100. In other words, at the outside of the furnace body 1100, a first container may be disposed below the first outlet, and a second container may be disposed below the second outlet. Here, for example, the first container in which the molten metal L discharged from the first outlet is accommodated may be a ladle, and the second container in which the slag S discharged from the second outlet may be a slag pot.

The cover 1200 is installed on the furnace body 1100 so as to close the upper opening of the furnace body 1100. The cover 1200 may have holes allowing a portion of each of the electrode part 2000, input part 3000, and the sensor unit 7000 to pass through.

The body part 1000, which includes the furnace body 1100 and the cover 1200, may have a square shape, and more specifically have a rectangular shape, as shown in FIGS. 1 and 2. That is, as shown in FIG. 1, the body part 1000 may have a rectangular shape having a length extending in one direction X-axis direction, which is shorter than that extending in the other direction Y-axis direction. In other words, the furnace body 1100 may have a rectangular shape having a length extending in one direction X-axis direction, which is shorter than that extending in the other direction Y-axis direction, and the cover 1200 may be provided in a shape corresponding to or identical to the furnace body 1100.

Here, the shape of the body part 1000 may not be limited thereto and may be circular. In addition, the shape of the body part 1000 may be changed to polygons other than a rectangle, for example, a triangle, a pentagon, or various other shapes.

This body part 1000 may be referred to as an electric furnace.

The electrode part 2000 supplies thermal energy to melt and reduce the raw material inside the body part 1000. This electrode part 2000 may have a shape extended in the vertical direction as shown in FIG. 2 and may be installed to pass through the cover 1200 of the body part 1000 in the vertical direction. Here, one of both ends of the electrode part 2000 in the extension direction may be disposed below the cover 1200, and the other end of the electrode part 2000 may be disposed above the cover. Also, when installing the one end of the electrode part 2000 inside the body part 1000, the one end of the electrode part 2000 is installed at a predetermined distance apart from an upper portion of the slag S. Additionally, the other end, which is protruding above the cover 1200, of the electrode part 2000 may be connected to a power supply part (not shown). Here, power may refer to voltage or current, and the heat generated in the electrode part 2000 may include resistance heat due to the applied power.

When the power supply part 4000 is operated to apply power to the electrode part 2000, the electrode part 2000 generates resistance due to slag S and arc resistance, supplying thermal energy into the body part 1000. Therefore, the slag is heated inside the body part 1000, and the raw material is melted by the heated slag S to manufacture molten metal L. In other words, as shown in FIGS. 2 and 4, a pile Pₘ (P_{cm} and Pₛₘ) is generated by the raw materials piled up on the upper portion of the slag S, and the raw material pile Pₘ is melted by the heated slag S, thereby manufacturing molten metal L.

In case of melting the raw material pile Pₘ (P_{cm} and Pₛₘ) inside the body part 1000, the raw material pile Pₘ (P_{cm} and Pₛₘ) begins to melt, starting from a layer of the raw material pile Pₘ (P_{cm} and Pₛₘ) that is most adjacent to the slag S, or a lower layer in contact with the slag S. Then, over time, the raw materials in upper layers thereof are melted as they move downward.

The electrode part 2000 may be installed, for example, to be disposed at a central part or a central area in one direction X-axis direction as shown in FIG. 1 and FIG. 4. Here, the central part or the central area in one direction X-axis direction may include an area from a central position in the one direction X-axis direction to a point at a predetermined distance from the central position.

Additionally, a plurality of electrode parts 2000 may be provided, and the plurality of electrode parts 2000 may be arranged to be spaced apart from each other in the other direction Y-axis direction that intersects or is orthogonal to one direction X-axis direction.

The plurality of electrode parts 2000 may be connected to a single power supply part, and the power supply part may control the power supplied to each of the plurality of electrode parts 2000. However, the power supply part is not limited thereto, and a plurality of power supply part may be provided to connect one-to-one with the plurality of electrode parts 2000.

The input part 3000 (3100 and 3200) may have a shape providing a passage through which the raw material M passes internally. For example, the input part 3000 may have a pipe shape with an internal passage and open ends on both sides. This input part 3000 may be installed to pass through the cover 1200 in the vertical direction. Here, one end of the input part 3000 may be disposed below the cover 1200, and the other end may protrude above the cover. Here, the other end of the input part 3000 disposed above the cover 1200 serves as an inlet through which the raw material is introduced into the input part 3000, while one end of the input part 3000 disposed below the cover 1200 serves as an outlet through which the raw material is discharged into the body part 1000.

A plurality of input parts 3000 are provided, and the plurality of input parts 3000 (3100 and 3200) are arranged and installed in one direction X-axis direction and in the other direction Y-axis direction that intersects the one direction X-axis direction, respectively. To explain this in other words, the input parts 3000 may be arranged in a plurality of rows in each of the one direction X-axis direction and the other direction Y-axis direction.

Hereinafter, for convenience of explanation, the input parts installed around the electrode part 2000 will be referred to as first input parts 3100. Also, input parts disposed on outer portions of the first input parts 3100 may be referred to as second input parts 3200 such that the second input parts are relatively farther from the electrode part 2000 than the first input parts 3100.

As shown in FIG. 1, when the electrode part is disposed at the central part in one direction X-axis direction, it may be described that the first input parts 3100 are input parts, which are installed at the central part in one direction X-axis direction to be disposed around the electrode part 2000. Additionally, it may be described that the second input parts 3200 are input parts disposed on both outer sides of each of the first input parts 3100 with respect to one side direction X-axis direction.

A case in which the electrode part 2000 is disposed at the central part in one direction and the first input part 3100 is disposed around the electrode part 2000 will be explained again as follows. The first input parts 3100 may be installed to be disposed at the central part in one direction X-axis direction so as to be disposed around the electrode part 2000. A plurality of first input parts 3100 are provided and arranged in the other direction Y-axis direction. Additionally, the plurality of first input parts 3100 may also be arranged in one direction X-axis direction. Moreover, each of the first input parts 3100 may be installed to be disposed between the two electrode parts 2000. That is, one first input part 3100 may be installed between two adjacent electrode parts 2000. In other words, the electrode part 2000 and the first input part 3100 may be alternately arranged in the other direction Y-axis direction. Additionally, the first input part 3100 may be installed between both sides in the other direction Y-axis direction and the electrode part inside the body part 1000.

The second input parts 3200 may be installed on both outer sides of the first input part 3100 in the one direction X-axis direction. A plurality of second input parts 3200 are provided and arranged in the other direction Y-axis direction. This second input part 3200 differs from the primary input part 3100 described earlier only in its installation position, while its shape or structure is the same. Therefore, the description for the second input part 3200 will be omitted.

As described above, the plurality of input parts 3000 are provided and arranged respectively in one direction X-axis direction and the other direction Y-axis direction. That is, the electric furnace equipment may include the plurality of first input parts 3100 and the plurality of second input parts 3200, and the plurality of first input parts 3100 and the plurality of second input parts 3200 are arranged in each of one direction X-axis direction and the other direction Y-axis direction. Thus, the positions of each of the plurality of first input parts 3100 and the plurality of second input parts 3200 are different from each other. The positions of each of the plurality of first input parts 3100 and the plurality of second input parts 3200 may each be stored in an input control part 8000 described below.

The storage part 5000 is a means for storing the raw material M to be input to the body part 1000, and the raw material stored in the storage part 5000 may include direct reduced iron. The storage part 5000 may include a first storage part 5100 where the raw material to be supplied to the first input part 3100 is stored, and a second storage part 5200 where the raw material to be supplied to the second input part 3200 is stored.

The supply unit 4000 is a means for supplying raw material to the plurality of input parts 3100, 3200. This supply unit 4000 may include a first supply unit 4100 that supplies the raw material M to the first input part 3100 and a second input part 3200 that supplies the raw material to the second input part 3200.

First, the first supply part 4100 will be explained.

The first supply unit 4100 may include a first transfer member 4110 installed to connect the first storage part 5100 and the first input part 3100, and a first adjustment member 4120 installed on the first transfer member 4110.

The first transfer member 4110 may have a pipe shape in which a passage is defined to allow the raw material M to pass therethrough. Both ends of the first transfer member 4110 may be opened, and one end of the first transfer member 4110 may be connected to the first input part 3100 and the other end may be connected to the first storage part 5100.

The first adjustment member 4120 adjusts the communication between the first storage part 5100 and the first input part 3100, and adjusts the input amount of material M. This first adjustment member 4120 may be installed on the first transfer member 4110 that connects between the first storage part 5100 and the first input part 3100. Also, the first adjustment member 4120 may be a means including a valve. This first adjustment member 4120 may adjust the communication between the first storage part 5100 and the first input part 3100 through its opening and closing operation. Additionally, the first control member 4120 may adjust the input amount of raw material M supplied to the first input part 3100 by adjusting its degree of opening. Here, adjusting the input amount may include adjusting the input rate. Also, the first control member 4120 is controlled in its operation by the input control part 8000 described below. In other words, at least one of the opening/closing status or the opening degree may be controlled by the input control part 8000.

The above-described first supply unit 4100 may be provided in multiple numbers so as to be connected to each of the plurality of first input parts 3100. In other words, the first supply unit 4100 may be individually connected to each of the plurality of first input parts 3100.

Second supply part 4200 supplies the raw material to the second input part 3200, and only differs in the target it supplies compared to supply unit 1 4100, its configuration is the same or similar. That is, the second supply unit 4200 may include a second transfer member 4210 installed to connect the second storage part 5200 and the second input part 3200, and a second adjustment member 4220 installed on the second transfer member 4210. Here, the second transfer member 4210 and the second adjustment member 4220 of the second supply part 4200 have the same shape and structure as the above-mentioned first transfer member 4110 and first adjustment member 4120. Therefore, the description of the second transfer member 4210 and the second adjustment member 4220 will be omitted.

The above-described second supply unit 4200 may be provided in multiple numbers so as to be connected to each of the plurality of second input parts 3200. In other words, the second supply unit 4200 may be individually connected to each of the plurality of second input parts 3200.

In the above, as shown in FIG. 1, it was explained that the plurality of first supply units 4100 are connected to one first storage part 5100, and the plurality of second supply units 4200 are connected to one second storage part 5200. However, it is not limited thereto, and each of the first storage part 5100 and the second storage part 5200 may be provided in multiples. In addition, the first supply unit 4100 may be connected to each of the plurality of first storage parts 5100, and the second supply unit 4200 may be connected to each of the plurality of second storage parts 5200.

Moreover, the first storage part 5100 and the second storage part 5200 may not be provided separately, and a single storage part may be provided. In this case, the plurality of first supply unit 4100 and the plurality of second supply part 4200 may be connected to a single storage part.

When the raw material M is input to the body part 1000 using the input part 3000, the raw material is accumulated on an upper portion of a surface of the slag S. Thus, a pile by the piled raw material is provided on the upper portion of the slag S, and hereinafter, it is referred to as a ‘raw material pile Pₘ’.

Additionally, since the raw material M is input to the body part 1000 by using the plurality of the first input part 3100 and the plurality of the second input part 3200, there are a plurality of raw material piles Pₘ (P_{cm} and Pₛₘ) provided inside the body part 1000. Here, the raw material piles Pm (P_{cm} and Pₛₘ) may be provided as the number of input parts 3000, and as shown in FIGS. 1 and 4, the raw material piles are disposed to correspond to a lower side of each of the plurality of input part 3000.

The raw material piles Pm (P_{cm} and Pₛₘ) may be disposed to face the lower side of the input parts 3000 (3100 and 3200) and provided in the same number as the input parts 3000 (3100 and 3200). That is, the raw material piles Pm (P_{cm} and Pₛₘ) may be disposed below of each of the plurality of input parts 3000 (3100 and 3200). In other words, the plurality of raw material piles Pm (P_{cm} and Pₛₘ) may be arranged in one direction X-axis direction and the other direction Y-axis direction.

Hereinafter, the raw material pile input from the first input part 3100 to the body part 1000 is referred to as a ‘first raw material pile P_{cm}’, and the raw material pile input from the second input part 3200 to the body part 1000 is referred to as a ‘second raw material pile Pₛₘ’.

Accordingly, the first raw material pile P_{cm} may explained as a raw material pile disposed around the electrode part 2000. For example, when the plurality of raw material piles are arranged in one direction with respect to the electrode part 2000, the raw material pile P_{cm} around the electrode part 2000 may refer to the raw material pile P_{cm} that is closest to the electrode part 2000 among the plurality of raw material piles arranged in that one direction. Furthermore, the plurality of raw material piles P_{cm} may be disposed around the electrode part 2000 in a circumferential direction of the electrode part 2000. In this case, the raw material piles P_{cm} around the electrode unit 2000 may be a plurality of raw material piles P_{cm} arranged in the circumferential direction around the electrode unit 2000. Also, when detecting the spacing distance between the electrode part 2000 and the raw material piles P_{cm} disposed around the electrode part 2000, a spacing distance Dcm between each of the plurality of raw material piles P_{cm} disposed around the electrode part 2000 and the electrode part 2000 may be detected.

Moreover, it may be described that the second raw material pile Pₛₘ is disposed outside the first raw material pile P_{cm}, so that the distance from the electrode unit 2000 is farther compared to the first raw material pile.

The sensor unit 7000:7100, 7200 is a means to measure a height of the raw material pile Pₘ (P_{cm} and Pₛₘ) and installed in the body part 1000. For example, the sensor unit 7000 may be installed to pass through the cover 1200 in the vertical direction. In other words, a hole through which the sensor unit 7000 may pass may be defined in the cover 1200, and the sensor unit 7000 may be inserted into the hole. Here, the sensor unit 7000 may be installed so that its end is disposed on the same plane as a bottom surface of the cover 1200. Here, the bottom surface of the cover 1200 may be referred to as a surface facing inside the body part 1000.

Sensor units 7000 (7100 and 7200) are means that measure and detect a spacing distance from the raw material piles Pm (P_{cm} and Pₛₘ) to detect the height of the raw material piles Pm (P_{cm} and Pₛₘ). That is, when the sensor units 7000 (7100 and 7200) measures the spacing distance from the raw material piles Pm (P_{cm} and Pₛₘ), the measured spacing distance may be transmitted to the input control part 8000. Also, the input control part 8000 may detect the height of the raw material piles Pm (P_{cm} and Pₛₘ) by using the spacing distance between the sensor units 7000 (7100 and 7200) and the raw material piles Pm (P_{cm} and Pₛₘ).

A method of detecting the spacing distance between the sensor units 7000 (7100 and 7200) and the raw material piles Pm (P_{cm} and Pₛₘ) and of detecting the height of the raw material piles Pm (P_{cm} and Pₛₘ) by using the detected spacing distance will be described later together with the input control part 8000.

The sensor unit 7000 (7100 and 7200) may include a distance sensor, i.e., a radar sensor, which emits electromagnetic waves into the body part 1000 and measures the distance using the electromagnetic waves that are reflected back. Here, the sensor unit 7000 is not limited to the above-mentioned radar sensor and may include an optical sensor that emits light such as ultrasound or infrared, and measures distance using the light that is reflected back. In the following, the sensor unit 7000 will be explained as an example including a radar sensor that emits electromagnetic waves.

Sensor unit 7000 (7100 and 7200) may be provided in the same or corresponding number as the input parts 3000, 3100, 3200. That is, the plurality of sensor units 7000 (7100 and 7200) may be provided in the same numbers as the input parts 3000, 3100 and 3200. Also, the sensor unit 7000 (7100 and 7200) may be arranged in pairs with the input parts 3000, 3100 and 3200. Specifically, as shown in FIG. 2, the sensor unit 7000 (7100 and 7200) may be disposed at one side of the input parts 3000, 3100 and 3200, and a one-to-one arrangement of the sensor unit 7000 (7100 and 7200) with each of the plurality of input parts may be provided.

Accordingly, the plurality of sensor units 7000:7100, 7200 may be arranged in the same manner as the plurality of input parts 3000, 3100 and 3200. Referring to FIG. 1, when explaining the arrangement of the plurality of sensor units 7000 (7100 and 7200), the plurality of sensor units 7000 (7100 and 7200) may be arranged in rows in each of one direction X-axis direction and the other direction Y-axis direction of the body part. To explain in the other words, the input parts 7000 (7100 and 7200) may be arranged in a plurality of rows in each of the one direction X-axis direction and the other direction Y-axis direction.

The raw material pile Pₘ (P_{cm} and Pₛₘ), generated by the discharge of raw material M from the input parts 3000, 3100, 3200, may be provided to have a predetermined angle of repose. This angle of repose may be adjusted according to size of the raw material particles and the ratio of sizes. Additionally, as shown in FIGS. 1 and 4, the raw material pile Pₘ (P_{cm} and Pₛₘ) may have a shape that widens toward the lower portion thereof. Also, a height in the center of a topmost layer of the raw material pile Pₘ (P_{cm} and Pₛₘ), may be the highest in the width direction.

When installing the sensor unit 7000:7100, 7200, the sensor units may be disposed at the central part in the width direction of the raw material pile Pₘ (P_{cm} and Pₛₘ). In other words, the sensor unit 7000:7100, 7200 may be installed to face the central part in the width direction of the raw material pile Pₘ (P_{cm} and Pₛₘ). Installing the sensor unit 7000:7100, 7200 at the central part in the width direction of the raw material pile Pₘ (P_{cm} and Pₛₘ), the position of the central part in the width direction of the raw material pile Pₘ (P_{cm} and Pₛₘ) may be identified through multiple tests or operations. Additionally, the installation of the sensor unit 7000 (7100 and 7200) in such a manner that it is disposed at the central part in the width direction of the raw material pile Pₘ (P_{cm} and Pₛₘ) is provided because the height in the center of the topmost layer of the raw material pile Pₘ (P_{cm} and Pₛₘ) may be the highest in the width direction.

Hereinafter, the sensor unit disposed at one side of the first input part 3100 is referred to as the first sensor unit 7100, and the sensor unit disposed at one side of the second input part 3200 is referred to as the second sensor unit 7200. Accordingly, it may be understood that the first sensor unit 7100 is a sensor unit installed around the electrode part 2000, and the second sensor unit 7200 is a sensor unit disposed on the outer side of the first sensor unit 7100 so that its distance from the electrode part 2000 is greater than that of the first sensor unit 7100.

As shown in FIG. 1, when the electrode part is disposed at the central part in one direction X-axis direction, it may be described that the first sensor unit 7100 is a sensor unit, which is installed at the central part in one direction X-axis direction to be disposed around the electrode part 2000. Additionally, it may be described that the second sensor unit 7200 is a sensor unit disposed on both outer sides of each of the first sensor unit 7100 with respect to one side direction X-axis direction.

The first sensor unit 7100 detects the spacing distance between the first sensor unit 7100 and the first raw material pile Pem. The distance between the first raw material pile P_{cm} detected by the first sensor unit 7100 is transmitted to the input control part 8000. The input control part 8000 detects a height of the first raw material pile P_{cm} using the spacing distance from the first raw material pile P_{cm}. Here, the height of the first raw material pile Pem may be a distance between the upper surface of the slag S and the topmost layer of the first raw material pile Pem.

The second sensor unit 7200 detects the spacing distance between the second sensor unit 7200 and the second raw material pile Pₛₘ. The distance between the second raw material pile Pₛₘ detected by the second sensor unit 7200 is transmitted to the input control part 8000. The input control part 8000 detects a height of the second raw material pile Pₛₘ using the spacing distance from the second raw material pile Pₛₘ. Here, the height of the second raw material pile Pₛₘ may be a distance between the upper surface of the slag S and the topmost layer of the second raw material pile Pₛₘ.

As described above, the sensor unit 7000 is disposed at one side of each of the plurality of input parts 3000. In other words, the first sensor unit 7100 is disposed at one side of each of the plurality of first input parts 3100, and the second sensor unit 7200 is disposed at one side of each of the plurality of second input parts 3200. Accordingly, the number of the first sensor unit 7100 may be the same as the first input part 3100, and the number of the second sensor unit 7200 may be the same as the second input part 3200.

Like this, the sensor units 7000:7100, 7200 are disposed at one side of the input parts 3000 (3100 and 3200), which could imply that the input parts 3000 (3100 and 3200) and the sensor units 7000:7100, 7200 are disposed in a one-to-one match or connection. For this purpose, the input part and the sensor unit may be installed on a single body, as shown in FIGS. 2 and 3. Specifically, the first input part 3100 and the first sensor unit 7100 are installed on one body 31 see FIG. 2, and the second input part 3200 and the second sensor unit 7200 may be installed on another body (not shown).

As described above, the first sensor unit 7100 is installed on one side of each of the plurality of first input parts 3100. The first sensor unit 7100 radiates the electromagnetic waves downward to detect the spacing distance from the first raw material pile Pom piled therebelow. Also, the detected spacing distance from the first raw material pile P_{cm} is transmitted to the input control part 8000. Here, the first sensor unit 7100 transmits information, including the position of the first input part 3100 that is matched or associated with the first sensor unit 7100, to the input control part 8000. In other words, the information transmitted by the first sensor unit 7100 to the input control part 8000 includes the position of the first input part 3100 associated with the first sensor unit 7100 and the spacing distance from the first raw material pile P_{cm} provided below the first input part 3100. Also, each of the plurality of sensor units 7100 may measure the spacing distance from the first raw material pile P_{cm} provided therebelow. Thus, the information transmitted by each of the plurality of first sensor units 7100 to the input control part 8000 includes the position of each first input part 3100 associated with the respective first sensor unit 7100 and the spacing distance from the first raw material pile P_{cm} provided beneath the first input part 3100.

Additionally, a second sensor unit 7200 is installed on one side of each of the plurality of second input parts 3200, and the second sensor unit 7200 detects the spacing distance from the second raw material pile Pₛₘ provided therebelow. The detected spacing distance from the second raw material pile Pₛₘ is transmitted to the input control part 8000. Here, the second sensor unit 7200 transmits information, including the position of the second input part 3200 that is matched or associated with the second sensor unit 7200, to the input control part 8000. In other words, the information provided by the second sensor unit 7200 includes the position of the second input part 3200 associated with the second sensor unit 7200 and the spacing distance from the second raw material pile Pₛₘ provided below the second input part 3200. Also, each of the plurality of second sensor units 7200 measures the spacing distance from the second raw material pile Pₛₘ provided therebelow. Therefore, the information provided by each of the plurality of second sensor units 7200 includes the position of each second input part 3200 associated with the respective second sensor unit 7200 and the spacing distance from the second raw material pile Pₛₘ provided below each second input part 3200.

Accordingly, the input control part 8000 may detect the height of each of the plurality of first raw material piles P_{cm} and the plurality of second raw material piles Pₛₘ based on the information transmitted each of the plurality of first sensor units 7100 and second sensor units 7200. In other words, the positions of the plurality of first raw material piles P_{cm} and the plurality of second raw material piles Pₛₘ differ from each other, and these positions are determined by the positions of the plurality of first input parts 3100 and the plurality of second input parts 3200. Additionally, each of the plurality of first sensor units 7100 and the plurality of second sensor units 7200 transmits the position information of the plurality of first input parts 3100 and the plurality of second input parts 3200 to the input control part 8000. Therefore, the input control part 8000 may detect the height of each of the plurality of first raw material piles P_{cm} and the plurality of second raw material piles Pₛₘ, which are disposed on different positions.

The photographing part 6000 is a means for photographing the inside of the body part 1000 to acquire an image or video data. For convenience of explanation, the data acquired from the photographing part 6000 will be referred to as ‘image data.’

The photographing part 6000 is installed in the body part 1000 to photograph the inside of the body part 1000. More specifically, the photographing part 6000 is installed in the body part 1000 to photograph the electrode unit 2000 and the first raw material pile P_{cm} provided around the electrode unit 2000.

The photographing part 6000 may be installed in the furnace body 1100 of the body part 1000, as shown in FIGS. 1 and 3. That is, the photographing part 6000 may be installed to pass through or be inserted into a sidewall of the furnace body 1100, as shown in the enlarged view of FIG. 3. More specifically, a hole 1111 may be provided in the sidewall of the furnace body 1100, into which at least a portion of the photographing part 6000 may be inserted. Furthermore, a transparent window 1110 may be installed to one end of the hole 1111 facing an inner space of the furnace body 1100. In this case, the window 1110 may be made of heat-resistant glass.

The photographing part 6000 is installed to be inserted into the hole 1111, with one end, specifically a lens, positioned to face the window 1110. Additionally, the photographing part 6000 is installed to be inclined to photograph the slag S disposed below inside the furnace body 1100. More specifically, in the photographing part 6000, when one side with the lens is referred to as one end, and the opposite side as the other end, the photographing part 6000 is installed at an incline so that the height decreases from the other end toward the one end.

The photographing part 6000 may be installed on each of both sidewalls of the furnace body 1100 along one direction X-axis direction. A plurality of photographing parts 6000 may be installed on both sidewalls of the furnace body 1100 in one direction X-axis direction, and these photographing parts 6000 may be arranged in the other direction Y-axis direction.

Furthermore, the photographing part 6000 may be installed on both sidewalls of the furnace body 1100 along the other direction Y-axis direction. FIG. 1 shows one photographing part 6000 installed on each of the sidewalls in the other direction Y-axis direction of the furnace body 1100, but a plurality of photographing parts 6000 may be installed. The plurality of photographing parts 6000 may be arranged in one direction X-axis direction.

Such photographing parts may include, for example, a three-dimensional scanning camera.

Hereinafter, the spacing distance between the electrode unit and the raw material pile is explained. with reference to FIG. 4.

The electrode unit 2000 is installed with a portion inserted inside the body part 1000, with one end disposed at a predetermined distance above the slag S. When power is applied to the electrode unit 2000, heat is generated by slag resistance and arc resistance, thereby heating the slag S. Additionally, the raw material pile Pₘ (P_{cm} and Pₛₘ), which is loaded or piled on an upper portion of the heated slag S, is melted by the heated slag S.

Meanwhile, when the electrode part 2000 comes into contact with the raw material pile Pₘ (P_{cm} and Pₛₘ), an arc may occur unstably when power is applied to the electrode part 2000. As a result, hunting may occur, where the current flows unevenly and not uniformly through the electrode part 2000. When current hunting occurs, operational instability of the furnace may arise, the operational efficiency of the electric furnace equipment may decrease, or the production rate of molten metal L may decrease. For example, problems such as uneven melting of the raw material over time, insufficient melting of the raw material, or an extended time required to melt the raw material may occur.

Therefore, when inputting the raw material M inside the body part 1000, it is necessary to ensure that the electrode part 2000 does not come into contact with the raw material pile. Specifically, raw material M is input so that the first raw material pile Pom, which forms around the electrode part 2000, does not come into contact with the electrode part 2000. Since the second raw material pile Pₛₘ is disposed outside of the first raw material pile P_{cm}, it does not come into contact with the electrode part 2000.

The fact that the electrode part 2000 and the first raw material pile P_{cm} do not come into contact is indicated that there is a spacing distance between the electrode part 2000 and the first raw material pile P_{cm}. When the electrode part 2000 and the first raw material pile Pem are spaced apart, the surface of the slag S disposed between the electrode part 2000 and the first raw material pile P_{cm} is exposed. When the power is applied to the electrode part 2000, the exposed surface of the slag S begins to heat, and the heat gradually spreads. This operation, where the first raw material pile Pom is not in contact with the electrode part 2000, and the surface of the slag S around the electrode part 2000 is exposed to manufacture molten metal L, is called OSBF Open Slag Bath Furnace operation.

The spacing distance D between the electrode part 2000 and the first raw material pile P_{cm}, or a surface area of the slag S exposed around the electrode part 2000, may vary depending on an amount of raw material input to the inside of the body part 1000 through the first input part 3100. That is, the more raw material input through the first input part 3100, the higher and wider the first raw material pile P_{cm}. Accordingly, the more raw material input through the first input part 3100, the smaller the spacing distance D between the electrode part 2000 and the first raw material pile P_{cm}, and thus the smaller the surface area of the slag S exposed around the electrode part 2000. Conversely, the less raw material fed through the first input part 3100, the lower and narrower the first raw material pile P_{cm}. Therefore, the less raw material input through the first input part 3100, the larger the spacing distance D between the electrode part 2000 and the first raw material pile Pem, and thus the larger the surface area of the slag S exposed around the electrode part 2000.

Here, the spacing distance D between the electrode part 2000 and the raw material pile P_{cm} refers to a horizontal spacing distance.

The smaller the spacing distance D between the electrode part 2000 and the first raw material pile P_{cm}, the higher the likelihood of current hunting occurring when power is applied to the electrode part 2000. In other words, hunting may occur, where the current flows unevenly and not uniformly through the electrode part 2000. In addition, significant hunting may occur due to increased unevenness of the current flowing through the electrode unit 2000. Conversely, the wider the distance D between the electrode unit 2000 and the first raw material pile P_{cm}, the larger the area of the slag S surface exposed to the outside, which may result in significant heat loss. Additionally, the larger the surface area of the exposed slag S, the higher the temperature of the molten metal L, which may cause the refractory material composing the body part 1000 to erode more quickly.

Therefore, it is necessary to expose the surface of the slag S around the electrode part 2000 to an appropriate area. To achieve this, the first raw material pile P_{cm} provided around the electrode part 2000 must be spaced at an appropriate distance from the electrode part 2000. For example, the appropriate spacing distance between the electrode part 2000 and the first raw material pile P_{cm} may be between 0.2 m and 1.0 m. Here, the appropriate spacing distance between the electrode part 2000 and the first raw material pile P_{cm} is not limited to the above-mentioned example and may vary depending on factors such as the area of the body part 1000 and the number of input parts installed.

Therefore, in this embodiment, during the operation of melting raw material in the body part 1000 to manufacture molten metal L, the spacing distance between the electrode part 2000 and the first raw material pile P_{cm} is measured, and the input amount of raw material into the body part 1000 is adjusted based on this spacing distance.

Here, adjusting the input amount of raw material includes the amount of raw material input over time. Thus, adjusting the input amount may also include adjusting the input speed.

The input control part 8000 includes a first input control part 8100 that detects the spacing distance between the electrode part 2000 and the first raw material pile P_{cm} using the image acquired by the photographing part 6000, and controls the operation of the first supply part 4100 based on the detected spacing distance.

Additionally, the input control part 8000 includes a second input control part 8200 that detects the height of the second raw material pile Pₛₘ using the spacing distance between the second sensor unit 7200 and the second raw material pile Pₛₘ, and controls the operation of the second supply part 4200 based on the detected height of the second raw material pile Pₛₘ.

Hereinafter, the first input control part will be described with reference to FIGS. 1 to 5.

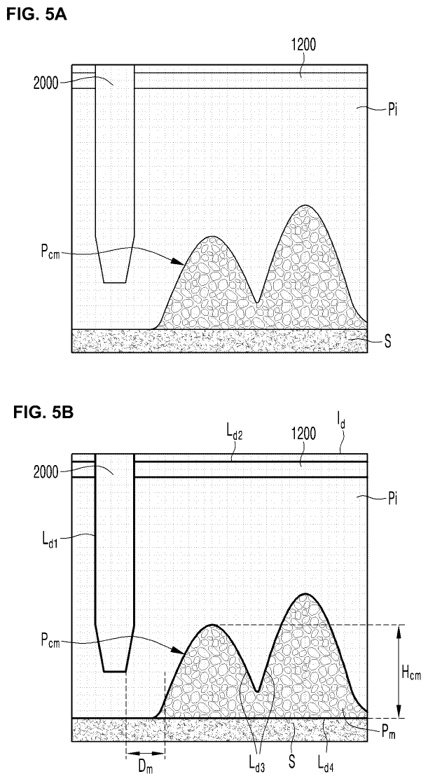

FIG. 5A is an example of a photograph image Iₛ acquired from a photographing part in accordance with an exemplary embodiment, and FIG. 5B is an example of an identification image I_{d} generated using the photograph image Iₛ.

Referring to FIGS. 1 and 3, the first input control part 8100 may include an identification image generator 8110 that converts the image acquired from the photographing part 6000 into an image hereinafter referred to as ‘identification image I_{d}’ where the electrode part 2000, the first raw material pile P_{cm}, and the slag S are distinguishable or identifiable, a distance detector 8120 that detects the spacing distance Dₘ between the electrode part 2000 and the first raw material pile Pom in the identification image I_{d}, and a first input controller 8140 that controls an operation of the first supply part 4100 based on the detected spacing distance Dₘ.

Additionally, the first input control part 8100 may include a first height detector 8130 that detects a height H_{cm} of the first raw material pile P_{cm} using a spacing distance Acm between the first sensor unit 7100 and the first raw material pile P_{cm}, a malfunction determiner 8150 that detects malfunctions of the first sensor unit 7100, and a second height detector 8160 that detects a height H_{cm} of the first raw material pile P_{cm} using the identification image I_{d} if it is determined that the first sensor unit 7100 is malfunctioning.

Here, the spacing distance Acm between the first sensor unit 7100 and the first raw material pile P_{cm} may refer to a vertical spacing distance.

Hereinafter, the image photographed by the photographing part 6000 before it is converted by the identification image generator 8110 will be referred to as the ‘photograph image Iₛ.’

The photographing part 6000 may photograph an area around the electrode part 2000. More specifically, the photographing part 6000 photographs the area around the electrode part 2000 to acquire a photograph image Iₛ that includes at least one of the electrode part 2000, the cover 1200 surrounding the electrode part 2000, the first raw material pile P_{cm} surrounding the electrode part 2000, and the slag S, as shown in FIG. 5A. Here, the components included in the photograph image Iₛ, such as the electrode part 2000, the cover 1200 surrounding the electrode part 2000, the first raw material pile P_{cm} surrounding the electrode part 2000, and the background, may be referred to as ‘objects.’

The identification image generator 8110 identifies the different objects included in the photographing image Iₛ. The identification image generator 8110 distinguishes and displays the identified objects to generate an identification image I_{d}. More specifically, the identification image generator 8110 identifies the different objects in the photographing image Iₛ, including the electrode part 2000, the cover 1200 surrounding the electrode part, the first raw material pile P_{cm}, and the slag S. The identified electrode part 2000, cover 1200, first raw material pile P_{cm}, and slag S are then distinguished and displayed to generate the identification image I_{d}, as shown in FIG. 5B.

Here, distinguishing the identified objects in the identification image generator 8110 may include, for example, marking or displaying a line hereinafter, referred to as an ‘identification line’ along the outermost part of each identified object. Referring to FIG. 5B as an example, the identification image generator 8110 may mark identification lines L_{d1}, L_{d2}, L_{d3}, and L_{d4} along the outermost portions of the identified electrode part 2000, the cover 1200 surrounding the electrode part, the first raw material pile P_{cm}, and the slag S, respectively.

Generating the above-described identification image I_{d} by the identification image generator 8110, may be provided using a segmentation technique based on artificial intelligence or deep learning. The segmentation technique is a method of extracting objects at a pixel Pi level from a photograph image Iₛ. In other words, when you want to know the location, shape, or which pixel Pi belongs to which object, the image iₛ divided, and each pixel of the image is labeled.

The identification or classification of objects using the segmentation technique in the identification image generator 8110 may be generated by deep learning. That is, the identification image generator 8110 may use a deep learning model trained with data where a user or operator has extracted and identified different objects in the photograph image to generate the identification image I_{d} hundreds or even thousands of times.

The distance detector 8120 detects the spacing distance Dₘ between the electrode part 2000 and the first raw material pile P_{cm} in the identification image I_{d}. Here, when the identification image I_{d} contains a plurality of first raw material piles P_{cm}, the distance detector 8120 detects the spacing distance Dₘ between the electrode part 2000 and the first raw material pile Pom that is located closest or nearest to the electrode part 2000. The distance detector 8120 also detects the spacing distance Dₘ between a lower portion of the first raw material pile P_{cm} and one end of the electrode part 2000. Here, the lower portion of the first raw material pile P_{cm} may refer to the part or region of the first raw material pile P_{cm} that touches the upper portion of the surface of the slag S. More specifically, the distance detector 8120 may detect the spacing distance Dₘ between a boundary where the first raw material pile P_{cm} in contact with the surface of the slag S and one end of the electrode part 2000. Here, the spacing distance Dₘ between the one end of the electrode part 2000 and the first raw material pile P_{cm} may be detected using the number of pixels Pi located between the identified one end of the electrode part and the first raw material pile P_{cm} in the identification image I_{d}, as well as the size of each pixel Pi.

The spacing distance Dₘ, which is detected by the distance detector 8120, between one end of the electrode part 2000 and the first raw material pile P_{cm}, may be transmitted to the first input controller 8140. The first input controller 8140 then determines the metho of inputting the raw material based on the detected spacing distance Dₘ. Here, a method of inputting the raw material may include a method a first method of maintaining the current amount of raw material being input from the first input part 3100 to the body part 1000, a method a second method of reducing the input amount of raw material from the first input part 3100, a method a third method of increasing the input amount of raw material from the first input part 3100, and a method a fourth method of stopping the raw material input from the first input part 3100.

Therefore, the first input controller 8140 selects or determines one of the above-described first to fourth methods based on the detected spacing distance Dₘ. For this purpose, a reference spacing distance, which serves as the basis for selecting the input method, is stored or set in the first input controller 8140. The reference spacing distance may include a first reference spacing distance D and a second reference spacing distance Dₜ₂, which is larger than the first reference spacing distance Dₜ₁. Additionally, the reference spacing distance may further include a third reference spacing distance Dₜ₃, which is smaller than the first reference spacing distance Dₜ₁.

The first input controller 8140 compares the detected spacing distance Dₘ with the first to third reference spacing distances Dₜ₁ to Dₜ₃ to select the input method.

For example, when the detected spacing distance Dₘ is greater than or equal to the first reference spacing distance Dₜ₁ and less than or equal to the second reference spacing distance Dₜ₂, the first input controller 8140 determines that the current input amount of raw material from the first input part 3100 to the body part 1000 will be maintained the first method.

In another example, when the detected spacing distance Dₘ is greater than or equal to the third reference spacing distance Dₜ₃ and less than the first reference spacing distance Dₜ₁, the first input controller 8140 determines that the input amount of raw material from the first input part 3100 will be reduced the second method.

In yet another example, when the detected spacing distance Dₘ exceeds the second reference spacing distance Dₜ₂, the first input controller 8140 determines that the input amount of raw material from the first input part 3100 will be increased the third method.

In further another example, when the detected spacing distance Dₘ is less than the third reference spacing distance Dₜ₃, the first input controller 8140 decides to stop the raw material input from the first input part 3100 the fourth method.

The determination of the raw material input method for each of the first input parts 3100 may be carried out for each of the plurality of first input parts 3100. That is, a plurality of photographing parts 6000 are provided to photograph the area around each of the plurality of first input parts 3100. Additionally, the photograph image Iₛ acquired from each imaging unit 6000 is transmitted to the identification image generator 8110 of the first input control part 8100. The identification image generator 8110 generates an identification image I_{d} for each of the plurality of photograph images Iₛ. Next, the distance detector 8120 detects the spacing distance Dₘ between the electrode part 2000 and the first raw material pile Pem in each identification image I_{d} using the plurality of identification images I_{d}. Therefore, the first input controller 8140 may determine the input method for each of the plurality of first input parts 3100 based on the detected plurality of spacing distances Dₘ.

When the first input controller 8140 determines the input method the second and third methods by deciding to reduce or increase the input amount of raw material, the first input controller 8140 determines the input amount of raw material. That is, when reducing or increasing the input amount compared to the current amount being input from the first input part 3100, the first input controller 8140 determines the amount of raw material to be input therethrough. Here, the first input controller 8140 determines the amount of raw material to be input through the first input part 3100 by using the height of the first raw material pile P_{cm}, as detected by the first sensor unit 7100 and the first height detector 8130.

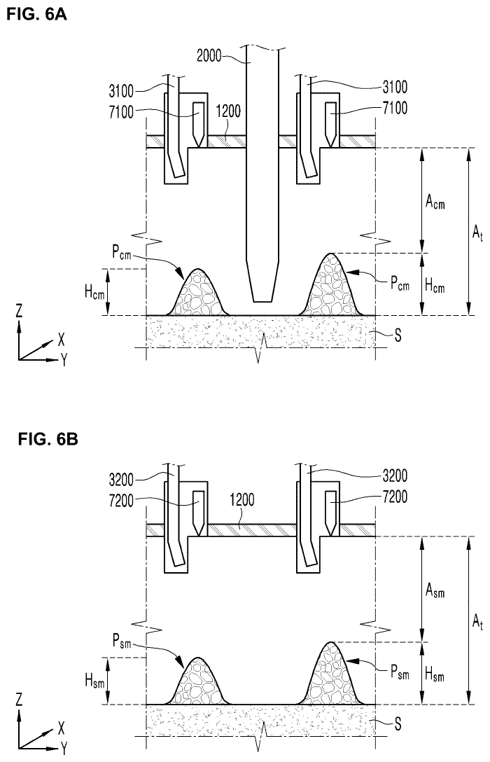

FIG. 6A is a view illustrating a method of detecting a height of a first raw material pile using a first sensor unit and a first height detector in accordance with an exemplary embodiment;

Hereinafter, with reference to FIG. 6 (a, a method of detecting a height H_{cm} of the first raw material pile P_{cm} using the first sensor unit 7100 and the first height detector 8130 according to the embodiment will be explained.

When the first sensor unit 7100 emits electromagnetic waves, the waves are reflected from the first raw material pile P_{cm} and then return to the first sensor unit 7100. Here, the first sensor unit 7100 is installed such that one end is positioned at the same height as the lower surface of the cover 1200. Additionally, the first sensor unit 7100 is installed at the central part in the width direction of the first raw material pile P_{cm}, which has the highest height at the center in the width direction of its topmost layer.

Since the electromagnetic waves emitted from the first sensor unit 7100 are directed toward the center in the width direction of the topmost layer of the first raw material pile P_{cm}, reflected off and then return to the first sensor unit 7100. The first sensor unit 7100 calculates or detects the spacing distance Acm between one end of the first sensor unit 7100 and the first raw material pile P_{cm} using the time it takes for the emitted electromagnetic waves to return after being reflected. In other words, the spacing distance Acm between the center in the width direction of the topmost layer of the first raw material pile P_{cm} and one end of the first sensor unit 7100 may be detected. The detected spacing distance A_{cm} between the first sensor unit 7100 and the first raw material pile P_{cm} is then transmitted to the first height detector 8130.

The first height detector 8130 detects the height H_{cm} of the first raw material pile P_{cm} by using the spacing distance A_{cm} between the first sensor unit 7100 and the first raw material pile P_{cm}, and a preset height Aₜ of the first sensor unit. Here, the height Aₜ of the first sensor unit 7100 may refer to a distance from the surface of the slag S to one end of the first sensor unit 7100. This height Aₜ of the first sensor unit 7100 may be a value measured the distance from the surface of the slag S to one end of the first sensor unit 7100. Alternatively, the height Aₜ of the first sensor unit 7100 may be a predetermined and stored value.

Additionally, since one end of the first sensor unit 7100 is installed at the same height as the lower surface of the cover 1200, the height Aₜ of the first sensor unit 7100 may be the same as the height of the lower surface of the cover 1200, measured from the surface of the slag S.

The first height detector 8130 calculates a difference between a spacing distance A_{cm} between the first sensor unit 7100 and the first raw material pile P_{cm} and the height Aₜ of the first sensor unit 7100 Aₜ-A_{cm}. The calculated result is detected as the height H_{cm} of the first raw material pile P_{cm}.

The first input controller 8140 uses the height H_{cm} of the first raw material pile P_{cm}, as detected by the first sensor unit 7100 and the first height detector 8130, to determine the amount of raw material to be input through the first input part 3100. Here, the first input controller 8140 determines the amount of raw material to be input by using the difference H_{ct}-H_{cm} between a reference height H_{ct} and the detected height H_{cm} of the first raw material pile P_{cm}.

Hereinafter, a detailed example is provided for further explanation. For example, when the spacing distance Dₘ between the electrode part 2000 and the first raw material pile P_{cm}, detected using the identification image I_{d}, is greater than or equal to the third reference spacing distance Dₜ₃ but less than the first reference spacing distance Dₜ₁, the first input controller 8140 determines to reduce the input amount of raw material from the first input part 3100 the second method. Also, the first input controller 8140 then determines the input amount of raw material using the height H_{cm} of the first raw material pile P_{cm}, detected by the first height detector 8130. In other words, the input amount of the raw material is determined based on the difference H_{ct}-H_{cm} between the reference height H_{ct} and the detected height H_{cm} of the first raw material pile P_{cm}. Here, the determined input amount of raw material may be determined to be less than the current input amount, and be calculated using the height difference H_{ct}-H_{cm}. In other words, the larger the difference H_{ct}-H_{cm} between the detected height H_{cm} of the first raw material pile Pom and the reference height H_{ct}, the smaller the determined input amount of the raw material. Conversely, the smaller the difference H_{ct}-H_{cm} between the detected height H_{cm} of the first raw material pile P_{cm} and the reference height H_{ct}, the larger the determined input amount of the raw material.

In another example, when the spacing distance Dₘ between the electrode part 2000 and the first raw material pile P_{cm}, detected using the identification image I_{d}, exceeds the second reference spacing distance Dₜ₂, the first input controller 8140 determines to increase the input amount of the raw material from the first input part 3100 the third method. Also, the first input controller 8140 then determines the input amount of the raw material using the height H_{cm} of the first raw material pile P_{cm}, detected by the first height detector 8130. In other words, the input amount of the raw material is determined based on the difference H_{ct}-H_{cm} between the reference height H_{ct} and the detected height H_{cm} of the first raw material pile P_{cm}. Here, the determined input amount of the raw material may be determined to be greater than the current input amount, and be calculated using the height difference H_{ct}-H_{cm}. In addition, the greater the difference H_{ct}-H_{cm} between the height H_{cm} of the detected first raw material pile P_{cm} and the reference height H_{ct}, the larger the determined input amount of raw material. In contrast, the smaller the difference H_{ct}-H_{cm} between the detected height H_{cm} of the first raw material pile P_{cm} and the reference height H_{ct}, the smaller the determined input amount of the raw material.

Meanwhile, the first sensor unit 7100 is installed closer to the electrode part 2000 and the exposed slag S compared to the second sensor unit 7200. Additionally, the first sensor unit 7100, which is a distance sensor that emits radar or light, is more susceptible to damage from heat than the photographing part 6000. When the first sensor unit 7100 is damaged, it may malfunction, leading to errors in the detected spacing distance A_{cm} between the first sensor unit 7100 and the first raw material pile P_{cm}.

For example, the spacing distance A_{cm} between the first sensor unit 7100 and the first raw material pile P_{cm} measured by the first sensor unit 7100 may be excessively large. Also, when the result is transmitted to the first height detector 8130, the height H_{cm} of the first raw material pile P_{cm} detected by the first height detector 8130 may be excessively low. This may indicate that the height H_{cm} of the first raw material pile P_{cm} is similar to the height of the surface of the slag S.

In contrast, the spacing distance A_{cm} between the first sensor unit 7100 and the first raw material pile P_{cm} measured by the first sensor unit 7100 may be excessively small. When the result is transmitted to the first height detector 8130, the height H_{cm} Of the first raw material pile P_{cm} detected by the first height detector 8130 may be excessively high. This may indicate that the height H_{cm} of the first raw material pile P_{cm} is similar to the height of the cover 1200.

In such cases, where the spacing distance A_{cm} between the first sensor unit 7100 and the first raw material pile P_{cm} measured by the first sensor unit 7100 is excessively large or small, it may not be used to determine the input amount of the raw material.

Therefore, the input control part 8000 according to the exemplary embodiment is provided with a malfunction determiner 8150 capable of judging whether the first sensor unit 7100 is malfunctioning. The malfunction determiner 8150 may judge the malfunction of the first sensor unit 7100 based on the spacing distance A_{cm} measured or detected between the first sensor unit 7100 and the first raw material pile P_{cm}.

For this purpose, the malfunction determiner 8150 has a malfunction judgment distance stored or set, which serves as a standard for judging malfunction. Here, the malfunction judgment distance may include a first malfunction judgment distance Aₑ₁ and a second malfunction judgment distance Aₑ₂, which is greater than the first malfunction judgment distance Aₑ₁.

The malfunction determiner 8150 judges that the first sensor unit 7100 is normally operating when the spacing distance A_{cm} between the first sensor unit 7100 and the first raw material pile P_{cm} detected by the first sensor unit 7100 is greater than or equal to the first malfunction judgment distance Aₑ₁ and less than or equal to the second malfunction judgment distance Aₑ₂.

However, when the spacing distance A_{cm} between the first sensor unit 7100 and the first raw material pile P_{cm} detected by the first sensor unit 7100 is less than the first malfunction judgment distance Aₑ₁ or exceeds the second malfunction judgment distance Aₑ₂, the malfunction determiner 8150 judges that the first sensor unit 7100 is malfunctioning.

When the malfunction determiner 8150 judges that the first sensor unit 7100 is malfunctioning, the second height detector 8160 detects the height of the first raw material pile P_{cm} using the identification image I_{d}. Referring to FIG. 5B, the second height detector 8160 detects the spacing distance between the surface of the slag S and the topmost layer of the first raw material pile Pₘ in the identification image I_{d} and uses this to detect the height H_{cm} of the first raw material pile P_{cm}. Here, the height H_{cm} of the first raw material pile P_{cm} may be calculated by using the number of pixels Pi disposed between the surface of the slag S and the topmost layer of the first raw material pile P_{cm}, as well as the size of each pixel Pi.

Once the height H_{cm} of the first raw material pile Pem is detected by the second height detector 8160, the first input controller 8140 determines the input amount of the raw material based on the detected height H_{cm} of the first raw material pile P_{cm}. Since the method of determining the input amount of the raw material by using the height H_{cm} of the first raw material pile Pom detected by the second height detector 8160 is the same as that by using the height H_{cm} detected by the first height detector 8130, the explanation will be omitted.

As described above, the height H_{cm} of the first raw material pile P_{cm} is measured primarily using the first sensor unit 7100, and when it is judged that the first sensor unit 7100 is malfunctioning, the height H_{cm} of the first raw material pile P_{cm} is measured using the identification image I_{d}. This is because the reliability of detecting the height of the raw material pile using the first sensor unit 7100, which emits electromagnetic waves or light, is higher than detecting the height of the raw material pile using the image photographed by the photographing part 6000. However, since the first sensor unit 7100 is more susceptible to damage from heat than the photographing part 6000, the height of the raw material pile is measured using the photographing part 6000 when it is judged that the first sensor unit 7100 is malfunctioning.

As described above, the determination of the input amount of raw material input from the first input part 3100 may be carried out for each of the plurality of first input parts 3100. In other words, the first height detector 8130 or the second height detector 8160 detects a height for each of the plurality of first raw material piles P_{cm}. In addition, in the first input controller 8140, the reference height H_{ct} may be set or stored for each position of the plurality of first input parts 3100. Here, the reference height H_{ct} for each position of the first input parts 3100 may vary according to the target height of the first raw material pile P_{cm} at each position. Thus, the first input controller 8140 may determine the input amount for each of the plurality of first input parts 3100 based on the detected height H_{cm} of each of the plurality of first raw material piles P_{cm}. Accordingly, the first input controller 8140 may control each of the plurality of supply parts 4000 so that the raw material is input according to the determined input method and input amount for each of the plurality of first input parts 3100.

In the above, the input method for the first input part 3100 is determined using the spacing distance Dₘ between the electrode part 2000 and the first raw material pile P_{cm}, and the input amount is determined using the height H_{cm} Of the first raw material pile P_{cm} detected by the first height detector 8130 or the second height detector 8160.

However, the method is not limited thereto, and both the input method and the input amount may be determined using the spacing distance Dₘ between the electrode part 2000 and the first raw material pile P_{cm}. Regarding this, it will be explained hereinafter.

For example, when the detected spacing distance Dₘ is greater than or equal to the third reference spacing distance Dₜ₃ and less than the first reference spacing distance Dₜ₁, the first input controller 8140 determines the input method the second method as reducing the input amount of the raw material from the first input part 3100. Next, the first input controller 8140 may calculate the difference Dₘ-Dₜ₁ between the detected spacing distance Dₘ and the first reference spacing distance Dₜ₁. Then, using the calculated difference Dₘ-Dₜ₁, it determines the input amount of the raw material. Here, the larger the difference Dₘ-Dₜ₁ between the detected spacing distance Dₘ and the first reference spacing distance Dₜ₁, the smaller the input amount is determined. In contrast, the smaller the difference Dₘ-Dₜ₁ between the detected spacing distance Dₘ and the first reference spacing distance Dₜ₁, the larger the input amount is determined.

In another example, when the detected spacing distance Dₘ exceeds the second reference spacing distance Dₜ₂, the first input controller 8140 determines the input method the third method as increasing the input amount of the raw material from the first input part 3100. Subsequently, the first input regulator 8140 calculates the difference Dₘ-Dₜ₁ between the detected spacing distance Dₘ and the second reference spacing distance Dₜ₂. Then, using the calculated difference Dₜ₂-Dₘ, it determines the input amount of the raw material. Here, the larger the difference Dₜ₂-Dₘ between the detected spacing distance Dₘ and the second reference spacing distance Dₜ₂, the larger the input amount is determined. In contrast, the smaller the difference Dₜ₂-Dₘ between the detected spacing distance Dₘ and the second reference spacing distance Dₜ₂, the smaller the input amount is determined.

Referring to FIGS. 1 and 3, the second input control part 8200 may include a third height detector 8210 that detects the height Hₛₘ of the second raw material pile Pₛₘ using the spacing distance Aₛₘ measured by using the second sensor unit 7200, and a second input controller 8220 that controls the operation of the second supply part 4200 based on the height Hₛₘ of the second raw material pile Pₛₘ detected by the third height detector 8210.

Hereinafter, with reference to FIG. 6B, a method of detecting the height Hₛₘ of the second raw material pile Pₛₘ using the second sensor unit 7200 and the third height detector 8220 according to the embodiment will be explained.

FIG. 6B is a view illustrating a method of detecting a height of a second material pile using a second sensor unit and a third height detector in accordance with an exemplary embodiment.

The second sensor unit 7200 measures the distance in the same manner as the first sensor unit 7100, with the only difference being its installation location. That is, when the second sensor unit 7200 emits electromagnetic waves, the waves are reflected from the second raw material pile Pₛₘ and then return to the second sensor unit 7200. Here, the second sensor unit 7200 is installed such that one end of it is positioned at the same height as the lower surface of the cover 1200. Additionally, the second sensor unit 7200 is installed at the central part in the width direction of the second raw material pile Pₛₘ, with the center of the width direction of the topmost layer of the second raw material pile Pₛₘ being the highest point.

The electromagnetic waves emitted from the second sensor unit 7200 may be directed toward the topmost layer of the second raw material pile Pₛₘ, reflected, and then return to the second sensor unit 7200. The second sensor unit 7200 calculates or detects the spacing distance Aₛₘ between one end of the second sensor unit 7200 and the second raw material pile Pₛₘ using the time it takes for the emitted electromagnetic waves to return after being reflected. In other words, it detects the spacing distance Aₛₘ between the central part in the width direction of the topmost layer of the second raw material pile Pₛₘ and one end of the second sensor unit 7200. The detected spacing distance Aₛₘ between the second sensor unit 7200 and the first raw material pile Pₛₘ is then transmitted to the third height detector 8210.

The third height detector 8210 detects the height Hₛₘ of the second raw material pile Pₛₘ using the spacing distance Aₛₘ between the second sensor unit 7200 and the second raw material pile Pₛₘ and a preset height Aₜ of the second sensor unit. Here, the height Aₜ of the second sensor unit may be the same as the height Aₜ of the first sensor unit 7100.

The third height detector 8210 calculates a difference Aₜ-Aₛₘ between the spacing distance Aₛₘ between the second sensor unit 7200 and the second raw material pile Pₛₘ and the height Aₜ of the second sensor unit 7200. Also the calculated result is then detected as the height Hₛₘ of the second raw material pile Pₛₘ.

The second input controller 8220 determines the input method and input amount at the second input part 3200 using the height Hₛₘ of the second raw material pile Pₛₘ detected by the second sensor unit 7200 and the third height detector 8210. For this purpose, in the second input controller 8220, a reference height may be set or stored, which serves as the basis for determining the input method and input amount.

Here, the reference height may include a first reference height Hₛₜ₁, a second reference height Hₛₜ₂, which is greater than the first reference height Hₛₜ₁, and a third reference height Hₛₜ₃, which is greater than the second reference height Hₛₜ₂.

The raw material input method may include maintaining the current input amount of raw material being input from the second input part 3200 to the body part 1000 first method, reducing the input amount of raw material from the second input part 3200 second method, increasing the input amount of raw material from the second input part 3200 third method, or stopping the input of raw material from the second input part 3200 fourth method.

Therefore, the second input controller 8220 determines or selects one of the first to fourth methods based on the detected height Hₛₘ of the second raw material pile Pₛₘ. That is, the second input controller 8220 compares the first to third reference heights Hₛₜ₁ to Hₛₜ₃ with the detected height Hₛₘ of the second raw material pile Pₛₘ and selects the input method accordingly.

For example, when the detected height Hₛₘ of the second raw material pile Pₛₘ is greater than or equal to the first reference height Hₛₜ₁ and less than or equal to the second reference height Hₛₜ₂, the second input controller 8220 decides to maintain the current input amount of raw material being input from a side first input part 3100 to the body part 1000 first method.

In another example, when the detected height Hₛₘ Of the second raw material pile Pₛₘ exceeds the second reference height Hₛₜ₂ but is less than or equal to the third reference height Hₛₜ₃, the second input controller 8220 decides to reduce the input amount of raw material from the second input part 3200 second method.

In yet another example, when the detected height Hₛₘ of the second raw material pile Pₛₘ is less than the first reference height Hₛₜ₁, the second input controller 8220 determines that the input amount of raw material from the second input part 3200 will be increased the third method.

In further another example, when the detected height Hₛₘ of the second raw material pile Pₛₘ exceeds the third reference height, the second input controller 8220 determines to stop the raw material input from the second input part 3200 fourth method.

When the second input controller 8220 determines the input method the second and third methods by deciding to reduce or increase the input amount of raw material, the second input controller 8220 determines the input amount of raw material. That is, when reducing or increasing the input amount compared to the current amount of the raw material being input from the second input part 3200, the second input part 3200 determines the amount of raw material to be input therethrough. In other words, the second input controller 8220 determines the input amount of raw material by using the difference between the first and second reference heights Hₛₜ₁, Hₛₜ₂ and the height H_{cm} of the second raw material pile Pₛₘ.

Hereinafter, a detailed example is provided for further explanation. For example, when the detected height Hₛₘ of the second raw material pile Pₛₘ exceeds the second reference height Hₛₜ₂ but is less than or equal to the third reference height Hₛₜ₃, the second input controller 8220 determines to reduce the input amount of the raw material from the second input part 3200 second method. Also, the second input controller 8220 then determines the input amount of raw material using the difference between the second reference height Hₛₜ₂ and the detected height Hₛₘ of the second raw material A Here, the determined input amount of raw material is determined to be less than the current input amount, and it is determined using the height difference Hₛₜ₂-Hₛₘ. The larger the difference between the detected height Hₛₘ of the second raw material pile Pₛₘ and the second reference height Hₛₜ₂, the smaller the input amount of raw material is determined. In contrast, the smaller the difference between the detected height Hₛₘ of the second raw material pile Pₛₘ and the second reference height Hₛₜ₂, the larger the input amount of raw material is determined.

In another example, when the detected height Hₛₘ of the second raw material pile Pₛₘ is less than the first reference height Hₛₜ₁, the second input controller 8220 decides to increase the input amount of raw material from the second input part 3200 third method. In addition, the second input controller 8220 then determines the input amount of raw material using the difference between the first reference height Hₛₜ₁ and the detected height Hₛₘ of the second raw material pile Pₛₘ. Here, the determined input amount of raw material is set to be greater than the current input amount, and it is determined using the height difference Hₛₜ₁-Hₛₘ. The larger the difference between the detected height Hₛₘ of the second raw material pile Pₛₘ and the first reference height Hₛₜ₁, the larger the input amount of raw material is determined. In contrast, the smaller the difference between the detected height Hₛₘ of the second raw material pile Pₛₘ and the second reference height Hₛₜ₂, the smaller the input amount of raw material is determined.

The method of adjusting the input amount of raw material from the second input part 3200 by the second input control part 8200 as described above may be applied to each of the plurality of second input parts 3200. That is, the second input control part 8200 may control the operation of each of the plurality of second supply parts 4200 using the same method as described above. More specifically, since a plurality of second sensor units 7200 are provided, the height of each of the plurality of second raw material piles Pₛₘ may be detected. Furthermore, the first to third reference heights Hₛₜ₁ to Hₛₜ₃ may be set or stored for each position of the plurality of second input parts 3200 in the second input controller 8220. Here, the first to third reference heights Hₛₜ₁ to Hₛₜ₃ for each position of the second input parts 3200 may vary depending on the target height of the second raw material pile Pₛₘ at each position. Therefore, the second input controller 8220 may determine the input method and input amount for each of the plurality of second input parts 3200 using the detected height Hₛₘ of each of the plurality of second raw material piles Pₛₘ. Consequently, the second input controller 8220 may control each of the plurality of second supply parts 4200 so that the raw material is input based on the determined input method and input amount for each of the plurality of second input parts 3200.

Like this, in the exemplary embodiment, the operation of the first supply part is controlled using the spacing distance between the electrode part and the first raw material pile. Additionally, the operation of the second supply part is controlled using the height of the second raw material pile.

Therefore, the input control part 8000 according to the embodiment can be described as controlling the first supply part 3100 and the second supply part 3200 separately or independently. Additionally, since the first supply part 3100 is controlled based on the spacing distance Dₘ between the electrode part 2000 and the first raw material pile Pₘ, and the second supply part 3200 is controlled based on the height of the second raw material pile Ps, it may be explained that the data used to control the operation of the first supply part 3100 and the conditions used to control the operation of the second supply part 3200 are different. That is, the input control part 8000 may control the input of raw materials into the body part 1000 based on the spacing distance Dₘ between the electrode part 2000 and the first raw material pile P_{cm} piled around the electrode part 2000, and it may be described as controlling the input of raw materials, which are input closer to the inner wall of the body part 1000 than the electrode part 2000, using data different from the spacing distance Dₘ.

In the above embodiment, the electric furnace equipment where the electrode part 2000 is disposed at the center in the X-axis direction of the body part 1000 was described as an example.

However, it is not limited thereto, and the electrode part 2000 may be installed in various positions inside the body part 1000. For example, the electrode part 2000 may be installed to one side of the body part 1000, biased toward one side of the X-axis direction. Additionally, the electrode part 2000 may be installed at both sides of the center of the X-axis direction. In another example, the electrode part 2000 may be installed at the central part of the Y-axis direction of the body part 1000, or biased toward one side of the Y-axis direction, or installed on both sides of the center of the Y-axis direction.

Furthermore, the first input part 3100 may be installed around the electrode part 2000, which may be installed in various positions, and the second input part 3200 may be installed outside the first input part 3100 so that it is positioned farther from the electrode part 2000 than the first input part 3100. Therefore, the positions of the first and second input parts 3100 and 3200 may vary depending on the position of the electrode part 2000. Therefore, the positions of the first and second input parts 3100 and 3200 may vary depending on the position of the electrode part 2000.

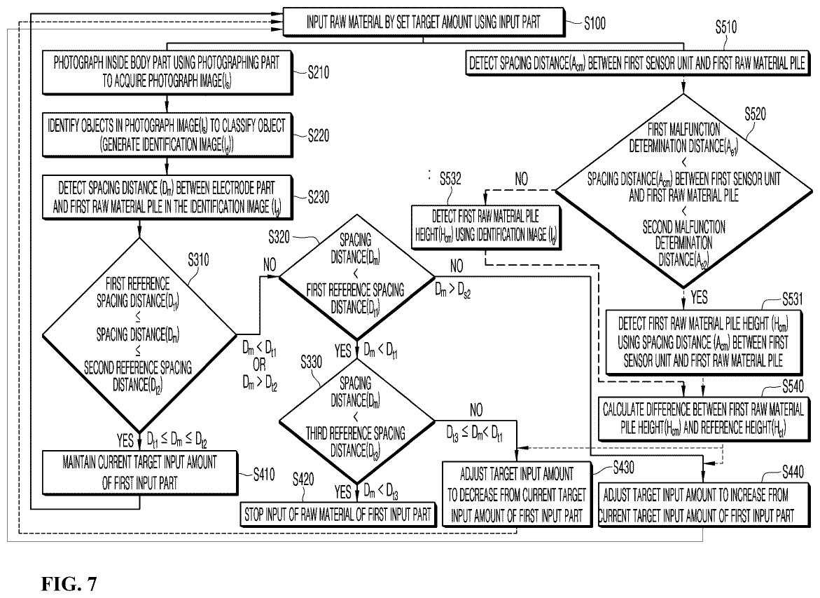

FIG. 7 is a flowchart illustrating a method of inputting a raw material to the body part using a first input control part in accordance with an exemplary embodiment.

Hereinafter, with reference to FIGS. 1 to 7, the operation of the electric furnace equipment including a process of inputting a raw material into the body part using the first input control part according to an exemplary embodiment will be described. Here, explanations that overlap with what is described above will be omitted or briefly explained. Next, an example will be provided where the electrode part 2000 is disposed at the central part in the X-axis direction of the body part 1000. Additionally, an example will be provided where the input amount of raw material is determined using the height of the first raw material pile.

For the manufacturing of molten metal L, raw material is input inside the body part 1000 using the plurality of input parts 3000 (3100 and 3200) (S100). That is, by opening the control members 4120 and 4220 of each of the plurality of supply parts 4000 (4100 and 4200), the raw material from the storage parts 5100 and 5200 is transferred to the input parts 3000 (3100 and 3200) through the transfer members 4110 and 4120. Accordingly, the raw material M is input into the interior of the body part 1000 through the input parts 3000 (3100 and 3200). Here, the raw material M may include, for example, direct reduced iron DRI. Additionally, a reducing agent may be input into the body part 1000 through a path different from that of the input parts 3000 (3100 and 3200), and the reducing agent may be a gas that includes hydrogen, for example.

Then, power is supplied to the electrode part 2000. Thus, the electrode part 2000 generates heat energy inside the body part 1000 by causing resistance from the slag S and arc resistance. As a result, the slag S inside the body part 1000 is heated, and the heated slag S melts the raw material, thereby producing molten metal.

While the molten metal L is being produced, the inside of the body part 1000 is photographed using the photographing part 6000 (S210). Accordingly, for example, a photograph image Iₛ like that shown in FIG. 5A is acquired. The photograph image Iₛ acquired by the photographing part 6000 is transmitted to the identification image generator 8110 of the first input controller 8100.

The identification image generator 8110 identifies objects included in the photograph image Iₛ and different from each other to generate an identification image I_{d} (S220). Specifically, the identification image generator 8110 identifies objects included in the photograph image Iₛ, such as the electrode part 2000, the cover 1200 around the electrode part 2000, the first raw material pile P_{cm} around the electrode part 2000, and the slag S. Then, the identification image generator 8110 marks or displays identification lines L_{d1}, L_{d2}, L_{d3}, and L_{d4} along the outer boundaries of the identified electrode part 2000, the cover 1200 around the electrode part 2000, the first raw material pile P_{cm} around the electrode part 2000, and the slag S, generating the identification image I_{d} that includes the identification lines L_{d1}, L_{d2}, L_{d3}, and L_{d4}.

When the identification image I_{d} is generated, it is transmitted to the distance detector 8120. The distance detector 8120 then detects the spacing distance Dₘ between the electrode part 2000 and the first raw material pile P_{cm} on the identification image I_{d} (S230). That is, the distance detector 8120 detects the spacing distance Dₘ between the lower portion of the first raw material pile P_{cm} and one end of the electrode part 2000. More specifically, the distance detector 8120 may detect the spacing distance between a boundary where the first raw material pile P_{cm} in contact with the surface of the slag S and one end of the electrode part 2000.

When the spacing distance Dₘ between the electrode part 2000 and the first raw material pile P_{cm} is detected, the first input controller 8140 determines the raw material input method based on the detected spacing distance Dₘ. In other words, the first input controller 8140 may select one of the following methods: maintaining the current input amount of raw material from the first input part 3100 first method, reducing the input amount of raw material from the first input part 3100 second method, increasing the input amount of raw material from the first input part 3100 third method, or stopping input of the raw material from the first input part 3100 fourth method.

For this purpose, the first input controller 8140 may firstly compare the detected spacing distance Dₘ with the first and second reference distances Dₜ₁ and Dₜ₂ (S310). When the detected spacing distance Dₘ is greater than or equal to the first reference spacing distance Dₜ₁ and less than or equal to the second reference spacing distance Dₜ₂ (S310→Yes), the first input controller 8140 selects the first method, which is to maintain the current input amount of raw material from the first input part 3100 (S410).

However, when the detected spacing distance Dₘ is not greater than or equal to the first reference spacing distance Dₜ₁ and less than or equal to the second reference spacing distance Dₜ₂ (S310→No), the detected spacing distance Dₘ is compared again with the reference distances (S320 and S330).

For example, the first input controller compares whether the detected spacing distance Dₘ is smaller than the first reference distance Dₜ₁ (S320). When the detected spacing distance Dₘ is less than the first reference distance Dₜ₁ (S320→Yes), it is further compared with the third reference distance Dₜ₃, which is smaller than the first reference distance Dₜ₁ (S330). When the detected spacing distance Dₘ is less than the third reference distance Dₜ₃ (S330→Yes), the first input controller 8140 decides to stop the raw material input from the first input part 3100 fourth method (S420). In this case, the first input controller 8140 may operate the first control member 4120 to ensure that no more raw material is discharged from the first input part 3100.

However, in the step (S320) of comparing whether the detected spacing distance Dₘ is smaller than the first reference spacing distance Dₜ₁, when it is determined that the detected spacing distance Dₘ is not smaller than the first reference spacing distance Dₜ₁ (S320→No), this means that the detected spacing distance Dₘ exceeds the second reference spacing distance Dₜ₂ (Dₘ>Dₜ₂). When the detected spacing distance Dₘ is determined to exceed the second reference spacing distance Dₜ₂ (S320→No), the first input controller 8140 determines the third method, which increases the input amount of raw material from the first input part 3100.

In another example, when it is determined at step S330 that the detected spacing distance Dₘ is not less than the third reference spacing distance Dₜ₃ (S330→No), it may be judged that the detected spacing distance Dₘ is greater than or equal to the third reference spacing distance Dₜ₃ and less than the first reference spacing distance Dₜ₁. When the detected spacing distance Dₘ is determined to be greater than or equal to the third reference spacing distance Dₜ₃ and less than the first reference spacing distance Dₜ₁ (S330→No), the first input controller 8140 determines the second method, which reduces the input amount of raw material from the first input part 3100 (S430).

The order in which the detected spacing distance Dₘ is compared with the first to third reference spacing distances Dₜ₁, Dₜ₂ and Dₜ₃ is not limited to the example described above, and various comparison orders may be used.

When the method of either decreasing or increasing the input amount of raw material is determined, the first input controller 8140 determines the amount of raw material to be input through the first input part 3100. For this, the first sensor unit 7100 emits electromagnetic waves into the body part 1000 and detects the spacing distance A_{cm} between the first sensor unit 7100 and the first raw material pile P_{cm} (S510). The spacing distance A_{cm} between the first sensor unit 7100 and the first raw material pile P_{cm} is first transmitted to the malfunction determiner 8150. The malfunction determiner 8150 compares the detected spacing distance A_{cm} with the first and second malfunction determination distances Aₑ₁, Aₑ₂ to determine whether the first sensor unit 7100 is malfunctioning (S520).

Here, the spacing distance A_{cm} between the first sensor unit 7100 and the first raw material pile P_{cm} is greater than or equal to the first malfunction determination distance Aₑ₁ and less than or equal to the second malfunction determination distance Aₑ₂, the malfunction determiner 8150 determines that the first sensor unit 7100 is operating normally (S520→Yes). Then, the first height detector 8130 calculates the height H_{cm} of the first raw material pile P_{cm} based on the detected spacing distance A_{cm} from the first sensor unit 7100 (S531).

The height H_{cm} of the first raw material pile P_{cm} detected by the first height detector 8130 is transmitted to the first input controller 8140, and the first input controller 8140 calculates the difference H_{ct}-H_{cm} between the detected height H_{cm} of the first raw material pile P_{cm} and the reference height H_{ct} (S540).

Using this height difference H_{ct}-H_{cm}, the first input controller 8140 determines the amount of raw material to be input into the body part 1000 through the first input part 3100. In other words, it determines the input amount of raw material. For example, when the second method is determined to decrease the input amount of raw material, the first input controller 8140 calculates the input amount to reduce the raw material input compared to the current amount based on the calculated height difference H_{ct}-H_{cm}. The first input controller 8140 then may operate the first supply unit 4100 to input the raw material at the determined amount. Thus, the raw material is input into the body part 1000 through the first input part 3100 at the determined input amount (S100).

In another example, when the third method is determined to increase the input amount of raw material, the first input controller 8140 determines the input amount to increase the raw material input based on the calculated height difference H_{ct}-H_{cm}. The first input controller 8140 then may operate the first supply unit 4100 to input the raw material at the determined amount. Thus, the raw material is input into the body part 1000 through the first input part 3100 at the determined input amount (S100).

Also, in the step of S520, when the spacing distance A_{cm} between the first sensor unit 7100 and the first raw material pile P_{cm} is less than the first malfunction determination distance Aₑ₁ or exceeds the second malfunction determination distance Aₑ₂, the malfunction determiner 8150 determines that the first sensor unit 7100 is malfunctioning (S520→No). In that case, the second height detector 8160 detects the height H_{cm} of the first raw material pile P_{cm} using the identification image I_{d} (S532). The detected height H_{cm} of the first raw material pile Pem is used to determine the input amount of raw material in the same way as previously described.

Adjusting the input amount of raw material from the first input part 3100 through the first input control part 8100 as described above is applied to each of the plurality of first input parts 3100. That is, the first input control part 8100 controls the operation of each of the plurality of first supply units 4100 in the same manner as described above.

To explain more specifically, the plurality of photographing parts 6000 are provided, and each of the plurality of first input parts 3100 is photographed. Additionally, the photograph image Iₛ acquired from each imaging unit 6000 is transmitted to the identification image generator 8110 of the first input control part 8100. The identification image generator 8110 generates an identification image I_{d} for each of the plurality of photograph images Is. Next, the distance detector 8120 detects the spacing distance Dₘ between the electrode part 2000 and first the raw material pile P_{cm} in each identification image I_{d} using the plurality of identification images Id. Therefore, the first input controller 8140 may determine the input method for each of the plurality of first input parts 3100 based on the detected plurality of spacing distances Dₘ. Also, the first height detector 8130 or the second height detector 8160 detects a height for each of the plurality of first raw material piles P_{cm}. Thus, the first input controller 8140 may determine the input amount for each of the plurality of first input parts 3100 based on the detected height H_{cm} of each of the plurality of first raw material piles P_{cm}. Accordingly, the first input controller 8140 may control each of the plurality of supply parts 4000 so that the raw material is input according to the determined input method and input amount for each of the plurality of first input parts 3100.

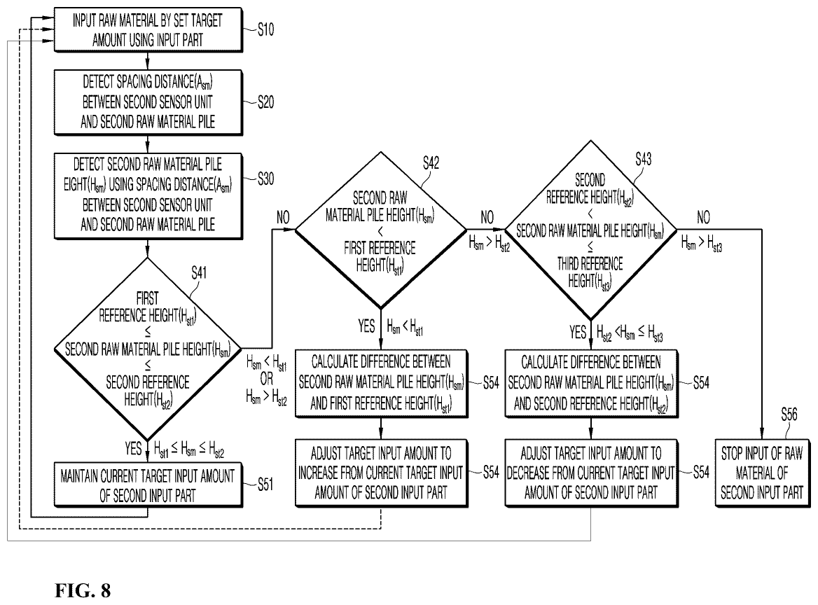

FIG. 8 is a flowchart illustrating a method of inputting the raw material to the body part using a second input control part in accordance with an exemplary embodiment.

Hereinafter, with reference to FIGS. 1 to 6 and FIG. 8, the operation of the electric furnace equipment including the process of inputting raw materials into the body part using the second input control part according to an exemplary embodiment will be described. Here, explanations that overlap with what is described in FIG. 7 will be omitted or briefly explained.

By inputting raw material into the inside of the body part 1000 using the plurality of first input parts 3100 and second input parts 3200 (S10) to manufacture molten metal L, the second sensor unit 7200 emits electromagnetic waves into the interior of the body part 1000 and detects the spacing distance Aₛₘ between the second sensor unit 7200 and the second raw material pile Pₛₘ (S20). Next, the third height detector 8210 may detect the height H_{cm} of the second raw material pile Pₛₘ using the detected spacing distance Aₛₘ from the second sensor unit 7200 (S30).

When the height H_{cm} of the second raw material pile Pₛₘ is detected, the second input controller 8220 determines the input method of raw material using the detected height H_{cm} of the second raw material pile Pₛₘ. In other words, the second input controller 8220 decides on one of the following methods: maintaining the current input amount of raw material into the body part 1000 from the second input part 3200 first method, reducing the input amount of raw material from the second input part 3200 second method, increasing the input amount of raw material from the second input part 3200 third method, or stopping the input of the raw material from the second input part 3200 fourth method.

To do so, the second input controller 8220 first compares the detected height H_{cm} of the second raw material pile Pₛₘ with the first and second reference heights Hₛₜ₁ and Hₛₜ₂ (S41. When the detected height H_{cm} of the second raw material pile Pₛₘ is greater than or equal to the first reference height Hₛₜ₁ and less than or equal to the second reference height Hₛₜ₂ (S310→Yes, the second input controller 8220 determines that the input amount of raw material currently being input from the second input part 3200 should be maintained (S51).

However, if the detected height Hₛₘ of the second raw material pile Pₛₘ is not equal to or greater than the first reference height Hₛₜ₁ and not equal to or less than the second reference height Hₛₜ₂ (S41→No), the detected height Hₛₘ is compared again with the reference heights (S42 and S43).

For example, first, the detected height Hₛₘ of the second raw material pile Pₛₘ is compared with the first reference height Hₛₜ₁ (When the detected height Hₛₘ is less than the first reference height Hₛₜ₁ (S42→Yes), the second input controller 8220 calculates the difference between the first reference height Hₛₜ₁ and the height Hₛₘ Of the second raw material pile Pₛₘ Hₛₜ₁-Hₛₘ (S52). Then, the second input controller 8220 determines the input metho of the raw material as the third method, which increases the input amount of raw material from the second input part 3200 (S53). In this case, the second input controller 8220 uses the difference between the first reference height Hₛₜ₁ and the height Hₛₘ of the second raw material pile Pₛₘ Hₛₜ₁-Hₛₘ to determine the input amount of input amount of raw material. In other words, the second input controller 8220 determines the input amount so that the raw material input increases compared to the current amount based on the calculated height difference Hₛₜ₁-Hₛₘ. Also, the second input controller 8220 operates the second supply unit 4200 so that the raw material is input in the determined amount. As a result, the raw material is input into the interior of the body part 1000 through the second input part 3200 in the determined amount (S100).

However, when the detected height Hₛₘ of the second raw material pile Pₛₘ is not less than the first reference height Hₛₜ₁ (S42→No), the height Hₛₘ of the second raw material pile Pₛₘ is compared with the second and third reference heights Hₛₜ₂ and Hₛₜ₃. In other words, it is determined whether the detected height Hₛₘ of the second raw material pile Pₛₘ exceeds the second reference height Hₛₜ₂ and is less than or equal to the third reference height Hₛₜ₃ (S43). When the detected height Hₛₘ of the second raw material pile Pₛₘ exceeds the second reference height Hₛₜ₂ and is less than or equal to the third reference height Hₛₜ₃ (S43→Yes), the second input controller 8220 calculates the difference between the second reference height Hₛₜ₂ and the height Hₛₘ of the second raw material pile Pₛₘ Hₛₜ₂-Hₛₘ (S54). Then, the second input controller 8220 determines the input method as the second method, which reduces the input amount of raw material from the second input part 3200 (S55). Here, the second input controller 8220 uses the difference between the second reference height Hₛₜ₂ and the height Hₛₘ of the second raw material pile Pₛₘ Hₛₜ₂-Hₛₘ to determine the input amount of raw material. In other words, the second input controller 8220 determines the input amount so that the raw material input decreases compared to the current amount based on the calculated height difference Hₛₜ₂-Hₛₘ. In addition, the second input controller 8220 then operates the second supply unit 4200 so that raw material is input in the determined amount. Thus, the determined amount of the raw material is input into the body part 1000 through the second input part 3200 (S100).

In the step of S43, when the detected height Hₛₘ of the second raw material pile Pₛₘ exceeds the second reference height Hₛₜ₂ and is not less than or equal to the third reference height Hₛₜ₃, this means that the height Hₛₘ of the second raw material pile Pₛₘ exceeds the third reference height Hₛₜ₃ (S43→No). In such a case, the second input controller 8220 determines the input method as the fourth method, which stops the raw material input from the second input part 3200 (S56). The second input controller 8220 then operates the first control member 4120 to ensure that no more raw material is discharged from the first input part 3100.

The method of controlling the input amount of raw material from the second input part 3200 as described above by the second input control part 8200 is applied to each of the plurality of second input parts 3200. In other words, the second input control part 8200 controls the operation of each of the plurality of second supply units 4200 in the same manner as described above. More specifically, as a plurality of second sensor units 7200 are provided, the height Hₛₘ of each of the plurality of second raw material piles Pₛₘ may be detected. Therefore, the second input controller 8220 may determine the input method and the input amount for each of the plurality of second input parts 3200 by using the detected heights Hₛₘ of the plurality of second raw material piles Pₛₘ. Accordingly, the second input controller 8220 may control each of the plurality of second supply units 4200 to input the raw materials according to the determined input method and input amount for each of the plurality of second input parts 3200.

According to the exemplary embodiments, the distance Dₘ between the electrode unit 2000 and the raw material pile may be detected. Based on the detected distance Dₘ between the electrode unit 2000 and the raw material pile, the raw material input may be controlled. This prevents the electrode unit 2000 from coming into contact with the raw material pile. As a result, when power is applied to the electrode unit 2000, current hunting in the electrode unit 2000 can be prevented. In other words, when power is applied to the electrode part 2000, a uniform current may flow through the electrode part 2000. Therefore, it is possible to heat the raw materials uniformly, which allows for uniform operations. Additionally, it may prevent issues such as the decrease in operating rate of electric furnace equipment and the production rate of molten metal due to hunting. Thus, the operating rate of the electric furnace equipment and the production rate of the molten metal may be improved.

In addition, the electrode unit and the raw material pile may be adjusted to be spaced at a predetermined distance apart from each other, allowing the slag to be exposed to an appropriate area. Therefore, the loss of heat and erosion of refractories caused by the exposed slag may be suppressed or prevented.

Furthermore, the height of plurality of raw material piles may be detected, and the input of raw materials may be controlled according to the detected height. Therefore, each of the plurality of raw material piles provided inside the body part 1000 may be provided to a targeted height.

### INDUSTRIAL APPLICABILITY

Therefore, according to the exemplary embodiments, the spacing distance between the electrode part and the raw material pile may be detected. In addition, the input of the raw material may be controlled according to the detected spacing distance between the electrode part and the raw material pile. This may prevent the electrode part from coming into contact with the raw material pile. Therefore, when power is applied to the electrode part, it is possible to prevent the hunting of current from occurring at the electrode part. As a result, a uniform current may flow through the electrode part. Therefore, it is possible to heat the raw materials uniformly, which allows for uniform operations. Additionally, it may prevent issues such as the decrease in operating rate of electric furnace equipment and the production rate of molten metal due to hunting. Thus, the operating rate of the electric furnace equipment and the production rate of the molten metal may be improved.

1. Electric furnace equipment comprising:
a body part having an inner space capable of processing a raw material;
an electrode part installed to be inserted into the inner space of the body part;
an input part installed in the body part to be capable of inputting the raw material to the inner space of the body part;
a photographing part installed in the body part to be capable of photographing an area around the electrode part in the inner space of the body part; and
an input control part which detects a spacing distance (Dₘ) between the electrode part and a raw material pile generated by the raw material piled around the electrode part by using a photograph image acquired by the photographing part and controls an input of the raw material input to the body part from the input part according to the detected spacing distance (Dₘ).

2. The electric furnace equipment of claim 1, further comprising a supply part configured to supply the raw material to the input part and connected to the input part to, adjust an amount of raw material supplied to the input part,
wherein the input control part is configured to control an operation of the supply part according to the detected spacing distance (Dₘ).

3. The electric furnace equipment of 1, wherein the input control part is configured to control the input of the raw material input to the body part according to the spacing distance (Dₘ) between the pile of the raw material piled around the electrode part and the electrode part and controls the input of the raw material input closer to an inner wall of the body part than the electrode part using data different from the spacing distance (Dₘ).

4. The electric furnace equipment of claim 3, wherein the body part comprises:
a furnace body having the inner space; and
a cover configured to cover an upper portion of the furnace body,
wherein the electrode part and the input part are installed to pass through the cover in a vertical direction, and the photographing part is installed to a sidewall of the furnace body, to photograph the inner space of the body part.

5. The electric furnace equipment of claim 4, wherein a hole, which passes through the sidewall of the furnace in a thickness direction, is defined, the photographing part is installed to be inserted to the hole, a transmissive window is installed to one end of the hole facing the inner surface of the furnace body, and the photographing part is installed to face the window.

6. The electric furnace equipment of claim 4, wherein the photographing part is installed to be inclined so that a height thereof decreases toward one end facing the inner space.

7. The electric furnace equipment of claim 4, wherein the input part comprises:
a first input part installed to be disposed around the electrode part; and
a second input part installed outside the first input part to be farther from the electrode part than the first input part,
wherein the photographing part is installed to acquire the photograph image comprising a first raw material pile, which is generated by inputting the raw material input from the first input part inside the body part, and the electrode part.

8. The electric furnace equipment of claim 7, wherein the supply part comprises:
a first supply part configured to supply the raw material to the first input part; and
a second supply part configured to supply the raw material to the second input part,
wherein the input control part comprises:
a first input control part configured to detect the spacing distance (Dₘ) between the electrode and the first raw material pile by using the photograph image, thereby controlling an operation of the first supply part by using the detected spacing distance (Dₘ); and
a second input control part configured to control an operation of the second supply part.

9. The electric furnace equipment of claim 8, wherein the first input control part comprises:
an identification image generator configured to identify the electrode part and the first raw material pile in the photograph image to generate an identification image in which the electrode part and the first raw material pile, which are identified, are distinguished from each other;
a distance detector configured to detect the spacing distance (Dₘ) between the electrode part and the first raw material pile by using the identification image; and
a first input controller configured to control the operation of the first supply part based on the spacing distance (Dₘ) detected by the distance detector,
wherein the first input controller is determined to determine a method of inputting the raw material from the first input part as one of maintenance, increase and decrease of the input amount, or stopping of the input, by using the detected spacing distance (Dₘ) and a preset reference spacing distance.

10. The electric furnace equipment of claim 9, further comprising a first sensor unit disposed at one side of the first input part to detect the spacing distance between the first raw material pile and the cover,
wherein the first input control part comprises a first height detector configured to detect a height (H_{cm}) of the first raw material pile by using the spacing distance between the first raw material pile and the cover, which is detected by the first sensor unit, and
the first input controller is configured to determine the input amount of raw material to be input through the first input part by using the height (H_{cm}) of the first raw material pile, when the input method from the first input part is determined as one of the increase and decrease of the input amount.

11. The electric furnace equipment of claim 9, wherein the first input control part comprises a second height detector configured to detect a height (H_{cm}) of the first raw material by using the identification image, and
the first input controller is configured to determine the input amount of raw material to be input through the first input part by using the height (H_{cm}) of the first raw material pile, when the input method from the first input part is determined as one of the increase and decrease of the input amount.

12. The electric furnace equipment of claim 9, wherein the first input controller is configured to determine the input amount of raw material to be input through the first input part by using a difference between the detected spacing distance (Dₘ) and the reference spacing distance, when the input method from the first input part is determined as one of the increase and decrease of the input amount.

13. The electric furnace equipment of claim 8, further comprising a second sensor unit disposed at one side of the second input part to detect a spacing distance between a second raw material pile, which is generated by the raw material input from the second input part inside the body part, and the cover,
wherein the second input control part comprises:
a third height detector configured to detect a height (Hₛₘ) of the second raw material pile by using the spacing distance between the second raw material pile and the cover, which is detected by the second sensor unit; and
a second input controller configured to control an operation of the second supply part, thereby controlling at least one of whether to input the raw material from the second input part or the input amount of raw material, based on the detected height (Hₛₘ) of the second raw material pile.

14. A method of manufacturing molten metal, the method comprising:
inputting a raw material to an electric furnace;
supplying power to an electrode part disposed in the electric furnace to melt the raw material;
photographing the inside of the electric furnace to acquire a photograph image comprising the electrode part and a raw material pile piled around the electrode part;
detecting a spacing distance (Dₘ) between the electrode part and the raw material pile by using the photograph image; and
controlling an input of the raw material input around the electrode part by using the detected spacing distance (Dₘ) between the electrode part and the raw material pile.

15. The method of claim 14, wherein the detecting of the spacing distance (Dₘ) between the electrode part and the raw material pile comprises:
identifying the electric part and the raw material pile in the photograph image to generate an identification image through which the electrode part and the raw material pile, which are identified, are distinguished from each other; and
detecting a spacing distance (Dₘ) between the electrode part and the raw material pile identified through the identification image.

16. The method of claim 15, wherein the controlling of the input of the raw material input around the electrode part comprises:
determining an input method as one of maintenance, increase, and decrease of the input amount, and stopping of the input based on the detected spacing distance (Dₘ) between the electrode part and the raw material pile; and
inputting the raw material around the electrode part according to the determined input method.

17. The method of claim 16, further comprising a detecting a height of the raw material,
wherein when the input method is determined as one of the increase and decrease of the input amount in the determining of the input method, the controlling of the input of the raw material input around the electrode part comprises determining the input amount of raw material by using the detected height of the raw material pile, and
in the inputting of the raw material based on the determined input method, the determined input amount of raw material is input.

18. The method of claim 17, wherein the detecting of the height of the raw material pile comprises:
emitting electromagnetic waves or light to the raw material pile by using a sensor unit disposed above the raw material pile to detect a spacing distance between the sensor unit and the raw material pile; and
detecting a height (H_{cm}) of the raw material pile by using the detected spacing distance between the sensor unit and the raw material pile.

19. The method of claim 18, further comprising judging malfunction of the sensor unit,
wherein the judging of the malfunction of the sensor unit comprises comparing the detected spacing distance between the sensor unit and the raw material pile and a predetermined malfunction judgement distance to judge the malfunction of the sensor unit,
when it is judged that the malfunction of the sensor unit occurs, the detecting of the height (H_{cm}) of the raw material pile comprises detecting a height (H_{cm}) of the raw material pile, which is identified on the identification image.

20. The method of claim 16, wherein when the input method is determined as one of the increase and decrease of the input amount in the determining of the input method, the controlling of the input of the raw material input around the electrode part comprises determining an input amount of raw material by using a difference between the detected spacing distance (D) between the electrode part and the raw material pile and a preset reference spacing distance,
wherein in the inputting of the raw material based on the determined input method, the determined amount of raw material is input.

21. (canceled)

22. (canceled)

23. (canceled)
